(19) United States
(12) Patent Application Publication
(10) Pub. No.: US 2026/0212622 A1
(43) Pub. Date: Jul. 23, 2026

(54) PROPORTION-CONTROLLED NEURAL BODY GENERATION

(71) Applicant: NVIDIA Corporation, Santa Clara, CA (US)

(72) Inventors: Aleksey KARMANOV, Yerevan (AM); Dmitry KOROBCHENKO, London (GB); Adeline AUBAME, Montréal (CA); Qiao WANG, Porter Ranch, CA (US); Miguel GUERRERO, Mission Hills, CA (US)

(73) Assignee: NVIDIA Corporation, Santa Clara, CA (US)

(21) Appl. No.: 19/033,081

(22) Filed: Jan. 21, 2025

(51) Int. Cl. G06T 19/20; G06N 3/08

(52) U.S. Cl. CPC G06T 19/20; G06N 3/08; G06T 2219/2016; G06T 2219/2021

(57) ABSTRACT

Various examples, systems, and methods are disclosed relating to a body generation pipeline. A first computing system can generate, according to a plurality of characteristics of a body of a subject, an initial model of the body. The first computing system further can determine a plurality of measurements of a plurality of structures of the initial model. The first computing system further can determine, by at least one neural network, based at least on the plurality of measurements, a plurality of modifications to the initial model, the at least one neural network updated according to training data including a featurized representation of example body shapes and measurements of samples of the featurized representation. The first computing system further can update the initial model according to the plurality of modifications.

### BACKGROUND

Generating anatomically accurate and diverse digital avatars presents challenges. Some traditional methods rely on fixed templates or manual adjustments for modeling human body shapes, leading to inefficiencies and reduced adaptability. These approaches can also result in limited accuracy and diversity, failing to represent the full range of possible body shapes and proportions. Current systems are inadequate at dynamically processing demographic and anatomical characteristics, such as gender, age, and relative stature, to generate realistic and personalized avatars. Additionally, traditional machine learning methods often rely on large-scale datasets and computationally intensive processes, limiting their practicality for scalable or real-time applications. This approach can result in static and generic or repetitive body models and an inability to adapt to diverse or dynamic requirements for digital human representations. The difficulty of creating anatomically accurate and diverse digital human models create inefficiencies, affecting the realism and computational efficiency of avatar generation for applications (e.g., virtual environments, simulation training, interactive media, and human-robot interaction).

### SUMMARY

Implementations of the present disclosure relate to systems and methods for improving the generation of anatomically accurate and diverse digital avatars using neural networks and dimensionality reduction techniques. Systems and methods are disclosed that can utilize neural networks (e.g., networks for length deformation, circumference deformation, base shape determination, etc.) and demographic characteristics to generate digital human models (e.g., anatomically realistic). For example, systems and methods in accordance with the present disclosure can generate a base shape of a body using coarse demographic inputs (e.g., gender, age, stature percentile) and refine the base shape using anatomical data, such as length measurements and circumference measurements. Additionally, the systems and methods can determine modifications (e.g., deformations) to the base shape by using neural networks trained on dimensionality-reduced representations of body shapes. By leveraging dimensionality reduction and feature blending techniques, the disclosed systems and methods can improve the accuracy, diversity, and computational efficiency of generating digital human models. These implementations improve avatar generation by providing scalable and realistic models that reflect diverse body proportions for applications such as simulation training, synthetic data generation, and human-computer interaction.

Some implementations relate to one or more processors including processing circuitry. In at least one embodiment, the processing circuitry generates, according to a plurality of characteristics of a body of a subject, an initial model of the body. The processing circuitry determines a plurality of measurements of a plurality of structures of the initial model. The processing circuitry determines, by at least one neural network, based at least on the plurality of measurements, a plurality of modifications to the initial model. In some implementations, the at least one neural network are updated according to training data include a featurized representation of example body shapes and measurements of samples of the featurized representation. The processing circuitry update the initial model according to the plurality of modifications.

In some implementations, the at least one neural network include a first neural network and a second neural network. In some implementations, determining the plurality of modifications to the initial model include applying the plurality of modifications to the first neural network to cause the first neural network to generate a plurality of length deformations of the plurality of modifications to the initial model. In some implementations, determining the plurality of modifications to the initial model includes applying the plurality of modifications to the second neural network to cause the second neural network to generate a plurality of circumference deformations of the plurality of modifications to the initial model.

In some implementations, the processing circuitry determines, by a third neural network of the at least one neural network, and based at least on the initial model, a plurality of base shapes of the initial model. In some implementations, the plurality of length deformations correspond to a first feature vector including a plurality of length measurements for the plurality of structures of the initial model. In some implementations, the plurality of circumference deformations correspond to a second feature vector including a plurality of circumference measurements for the plurality of structures of the initial model. In some implementations, the plurality of base shapes correspond to a third feature vector including principal component coefficients representing the plurality of base shapes in the initial model.

In some implementations, updating the initial model includes blending at least the first feature vector, the second feature vector, and the third feature vector. In some implementations, the second feature vector is blended based at least one isolating at least one feature of the second feature vector based at least on a body part of the body. In some implementations, the featurized representation is generated based at least on reducing a dimensionality of a dataset of body shape data to represent the dataset in a lower-dimensional vector space. In some implementations, the plurality of characteristics of the body of the subject include at least one of a gender percentile, an age percentile, or a stature percentile. In some implementations, generating the initial model includes using non-linear interpolation of the plurality of characteristics from a set of anchor shapes to a final statured result.

Some implementations relate to one or more processors including processing circuitry. The processing circuitry samples an input body shape from one or more datasets of body shapes. The processing circuitry measures a plurality of measurements of a model corresponding to the input body shape. The processing circuitry applies the plurality of measurements as input to a neural network to cause the neural network to generate an estimated representation of the model. The processing circuitry updates the neural network based at least on the input body shape and the estimated representation of the model.

In some implementations, the processing circuitry determines a set of anchor shapes from the one or more datasets of body shapes. In some implementations, the set of anchor shapes include predetermined body shapes representing a plurality of anatomical proportions based at least on one or more characteristics. In some implementations, the one or more characteristics correspond with at least one of a gender percentile, an age percentile, or a relative stature percentile. In some implementations, the processing circuitry determines, based at least on the set of anchor shapes, a plurality of initial coefficients corresponding to at least one shape parameter. In some implementations, the plurality of initial coefficients correspond to a plurality of shape variations of the set of anchor shapes for the input body shape.

In some implementations, determining the plurality of initial coefficients includes applying a dimensionality reduction operation to the one or more datasets of body shapes to generate the plurality of initial coefficients corresponding to a featurized representation of example body shapes within the one or more datasets of body shapes. In some implementations, updating the neural network includes determining an error value based at least on a plurality of output coefficients of the estimated representation of the model and the plurality of initial coefficients corresponding to the input body shape. In some implementations, updating the neural network includes updating one or more parameters of the neural network based at least on the error value. In some implementations, the processing circuitry are to update plurality of measurements based at least on augmenting the plurality of measurements by applying one or more multipliers or scaling factors to the plurality of measurements prior to applying the augmented plurality of measurements as input to the neural network.

Some implementations relate to a method. The method includes generating, using one or more processors according to a plurality of characteristics of a body of a subject, an initial model of the body. The method includes determining, using the one or more processors, a plurality of measurements of a plurality of structures of the initial model. The method includes determining, using the one or more processors by at least one neural network, based at least on the plurality of measurements, a plurality of modifications to the initial model. In some implementations, the at least one neural network are updated according to training data including a featurized representation of example body shapes and measurements of samples of the featurized representation. The method includes updating, using the one or more processors, the initial model according to the plurality of modifications.

In some implementations, the at least one neural network include a first neural network and a second neural network. In some implementations, determining the plurality of modifications to the initial model include applying, using the one or more processors, the plurality of modifications to the first neural network to cause the first neural network to generate a plurality of length deformations of the plurality of modifications to the initial model. In some implementations, determining the plurality of modifications to the initial model include applying, using the one or more processors, the plurality of modifications to the second neural network to cause the second neural network to generate a plurality of circumference deformations of the plurality of modifications to the initial model.

In some implementations, the method includes determining, using the one or more processors by a third neural network of the at least one neural network, based at least on the initial model, a plurality of base shapes of the initial model. In some implementations, the plurality of length deformations correspond to a first feature vector including a plurality of length measurements for the plurality of structures of the initial model. In some implementations, the plurality of circumference deformations correspond to a second feature vector including a plurality of circumference measurements for the plurality of structures of the initial model. In some implementations, the plurality of base shapes correspond to a third feature vector including principal component coefficients representing the plurality of base shapes in the initial model. In some implementations, updating the initial model includes blending at least the first feature vector, the second feature vector, and the third feature vector. In some implementations, the second feature vector is blended based at least one isolating at least one feature of the second feature vector based at least on a body part of the body.

The processors, systems, and/or methods described herein can be implemented by or included in at least one of a system for performing collaborative content creation for 3D assets, a system for performing deep learning operations, a system for generating or presenting one or more of augmented reality content, virtual reality content, or mixed reality content, a system for performing simulation operations, a system for performing real-time streaming, a system implementing one or more multi-model language models, a system implementing one or more large language models (LLMs), a system implementing one or more small language models (SLMs), a system implementing one or more vision language models (VLMs), a system using or deploying one or more inference microservices, a system that incorporates one or more machine learning models deployed in a service or microservice along with an OS-level virtualization package (e.g., a container), a system for generating synthetic data, a system for generating synthetic data using AI, a control system for an autonomous or semi-autonomous machine, a perception system for an autonomous or semi-autonomous machine, a system for performing digital twin operations, a system for performing light transport simulation, a system for performing remote operations, a system implemented using an edge device, a system implemented using a robot, a system for performing conversational AI operations, a system incorporating one or more virtual machines (VMs), a system implemented at least partially in a data center, and/or a system implemented at least partially using cloud computing resources.

### BRIEF DESCRIPTION OF THE DRAWINGS

The present systems and methods for proportion-controlled neural body generation are described in detail below with reference to the attached drawing figures, wherein:

FIG. 1 is a block diagram of an example of a system, in accordance with some implementations of the present disclosure;

FIG. 2A is a flow diagram of an example of a method for body generation in a body generation pipeline, in accordance with some implementations of the present disclosure;

FIG. 2B is a flow diagram of an example of a method for neural network updating and/or training in a body generation pipeline, in accordance with some implementations of the present disclosure;

FIG. 3A is an example illustration of human figure generation, in accordance with some implementations of the present disclosure;

FIG. 3B is an example illustration of coarse selection data, in accordance with some implementations of the present disclosure;

FIG. 3C is an example illustration of non-linear interpolation, in accordance with some implementations of the present disclosure;

FIG. 3D is a block diagram of a coarse solution process, in accordance with some implementations of the present disclosure;

FIG. 4A is a block diagram of a fine solution process, in accordance with some implementations of the present disclosure;

FIG. 4B is a block diagram of a neural network, in accordance with some implementations of the present disclosure;

FIG. 4C is a block diagram of neural network updating and/or training, in accordance with some implementations of the present disclosure;

FIG. 4D is a block diagram of a fine solution process, in accordance with some implementations of the present disclosure;

FIG. 4E is a block diagram of a fine solution final result generation, in accordance with some implementations of the present disclosure;

FIG. 5A is a block diagram of an example generative language model system suitable for use in implementing at least some implementations of the present disclosure;

FIG. 5B is a block diagram of an example generative language model that includes a transformer encoder-decoder suitable for use in implementing at least some implementations of the present disclosure;

FIG. 5C is a block diagram of an example generative language model that includes a decoder-only transformer architecture suitable for use in implementing at least some implementations of the present disclosure;

FIG. 6 is a block diagram of an example computing device suitable for use in implementing at least some implementations of the present disclosure; and

FIG. 7 is a block diagram of an example data center suitable for use in implementing at least some implementations of the present disclosure.

### DETAILED DESCRIPTION

This disclosure relates to systems and methods for digital avatar generation, such as proportion-controlled neural body generation. Some systems can generate digital models of subjects, such as digital avatars that represent realistic human body shapes. However, such models can lack realism and diversity with respect to the body shapes. For example, the models may not be generated in a manner reflective of the overall domain of possible body shapes, or may have unrealistic proportions even where controls are provided to adjust certain aspects of the body shapes.

Some techniques for digital avatar generation use fixed templates or manual adjustments, which often result in limited diversity and lack of realism in body shapes, leading to inefficient processing and limited accuracy representation of diverse body types. These techniques can fail to generate high-quality digital avatars, as the techniques often do not adapt to variations in body proportions or demographics. The limitations relate to how these techniques process and handle anatomical diversity, demographic adaptability, and/or efficiency. For example, template-based models can produce repetitive and unrealistic shapes and manual techniques can introduce inconsistencies and are often labor-intensive, resulting in a lack of accuracy and diversity in digital avatars. Additionally, inadequate body shape modeling techniques can prevent effective processing within limited computational resources, thereby leading to inefficiencies in digital avatar applications.

Systems and methods in accordance with the present disclosure can allow for more realistic and/or diverse generation of body shapes for models of the body shapes. That is, systems and methods in accordance with the present disclosure can improve realism and diversity in digital avatar generation by using neural networks to determine body proportions based at least on coarse inputs (e.g., gender, age, stature percentile, and/or other demographic characteristics) and/or fine inputs (e.g., anatomical data, base measurements, length changes, and/or circumference changes). For example, the system can generate, according to a plurality of characteristics of a body of a subject, an initial model (e.g., base shapes) of the body. The system can determine a plurality of measurements (e.g., of the base shapes) of a plurality of structures of the initial model. Additionally, the system can determine (e.g., by at least one neural network) a plurality of modifications (e.g., deformations, such as, but not limited to, predicted circumferences, predicted lengths) to the initial model. That is, the determination can be performed based at least on the plurality of measurements (e.g., base measurements for body part lengths and circumferences). The at least one neural network (e.g., at least one neural network for length deformation, at least one neural network for circumference deformations) can be updated according to training data including a featurized representation (e.g., decompositions with various vector representations of a body dataset) of example body shapes and measurements of samples of the featurized representation. The system can update the initial model (e.g., from the blending of at least the predicted deformations) according to the plurality of modifications. Thus, the systems and methods provide improvements in generating anatomically accurate and diverse digital human models by using neural networks to determine body shape modifications based on demographic and anatomical data, improving avatar generation.

In some implementations, the system can determine the plurality of modifications to the initial model by using at least one neural network including a first neural network and a second neural network. For example, the system can apply the modifications to the first neural network to generate a plurality of length deformations for the initial model and apply the modifications to the second neural network to generate a plurality of circumference deformations for the initial model. Additionally, the system can use a third neural network to determine a plurality of base shapes based at least on the initial model. For example, the third neural network can process features of the initial model to generate base shapes that provide reference proportions. In some implementations, the system can generate a first feature vector and a second feature vector corresponding to length and circumference deformations, respectively, and a third feature vector corresponding to the base shapes. For example, the first feature vector can include length measurements, the second feature vector can include circumference measurements, and the third feature vector can include principal component coefficients representing the base shapes.

In some implementations, the system can update the initial model by blending the first, second, and third feature vectors. Additionally, the system can isolate specific features in the second feature vector based on a body part of the model, allowing blending of circumference attributes without affecting length or other regions. In some implementations, the system can generate a featurized representation by reducing the dimensionality of a dataset of body shape data. For example, the system can apply dimensionality reduction to represent the dataset in a lower-dimensional vector space that retains body shape characteristics. Additionally, the system can use characteristics of the subject, such as a gender percentile, an age percentile, or a stature percentile, to inform the generation of the model. For example, generating the initial model can include using non-linear interpolation between anchor shapes. In some implementations, the system can interpolate between selected anchor shapes based on the characteristics of the subject to output a final statured result that reflects realistic body proportions.

In some implementations, the system can update and/or train the neural networks by sampling an input body shape (e.g., select a body shape from a dataset of existing body shapes such as Triplegangers Body Model (TGBM) and/or anchor shapes) from one or more datasets of body shapes. The system can measure a plurality of measurements of a model corresponding to the input body shape. Additionally, the system can apply (e.g., augment by random multiplication and/or scaling factor) the plurality of measurements as input to a neural network to cause the neural network to generate an estimated representation (e.g., set of coefficients) of the model (e.g., 3D shape model based at least on the input body shape). The system can update the neural network based at least on the input body shape and the estimated representation of the model (e.g., by calculating the mean squared error loss between the generated and target coefficients). Thus, the systems and methods provide improvements in training neural networks for digital human modeling by applying dimensionality reduction, targeted deformations, and feature vector blending to provide efficient and realistic body shape representation.

In some implementations, the system can determine a set of anchor shapes from one or more datasets of body shapes. For example, the set of anchor shapes can include predetermined body shapes representing various anatomical proportions based on one or more characteristics. Additionally, the characteristics can include at least one of a gender percentile, an age percentile, or a stature percentile, facilitating the selection of anchor shapes that reflect body proportions for different demographics. In some implementations, the system can determine a plurality of initial coefficients based on the set of anchor shapes. For example, the system can determine the initial coefficients to represent shape parameters that capture variations in body shapes across the anchor shapes. Additionally, the system can apply a dimensionality reduction operation to the datasets of body shapes to generate the initial coefficients. For example, the dimensionality reduction operation can output a featurized representation of example body shapes (e.g., facilitating the encoding of the body shape data into the initial coefficients). In some implementations, the system can update the neural network by determining an error value between the output coefficients of the estimated representation of the model and the initial coefficients corresponding to the input body shape. For example, the system can update the neural network parameters based on the error value. Additionally, the system can augment the plurality of measurements by applying one or more multipliers or scaling factors before using them as input to the neural network.

The systems and methods described herein can be used for a variety of purposes, including but not limited to, enhancing virtual training environments, improving human-robot interaction, generating accurate human models for synthetic data, and providing diverse digital avatars for interactive applications. Moreover, these methods can improve the efficiency and applicability of digital human modeling processes, such as in simulation training, avatar customization, and health and fitness applications.

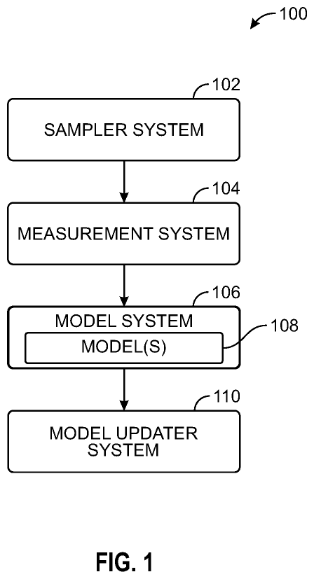

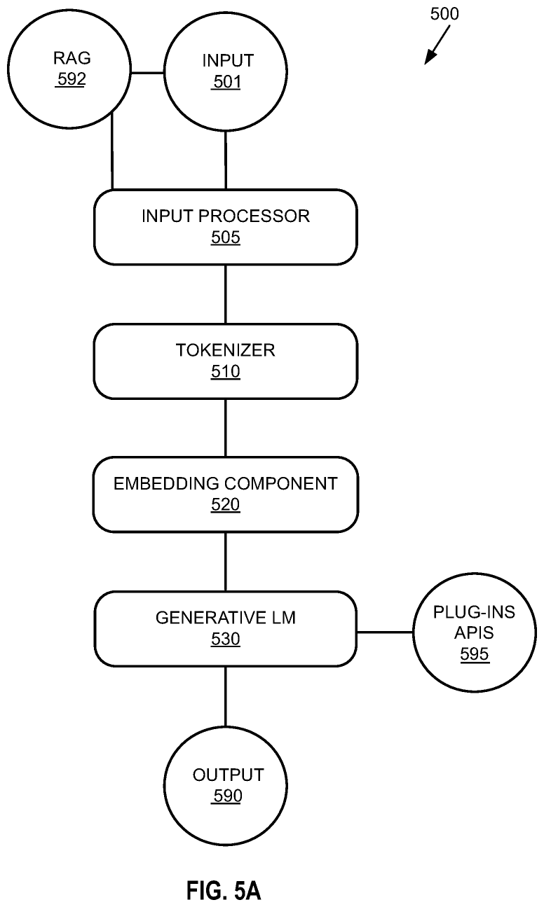

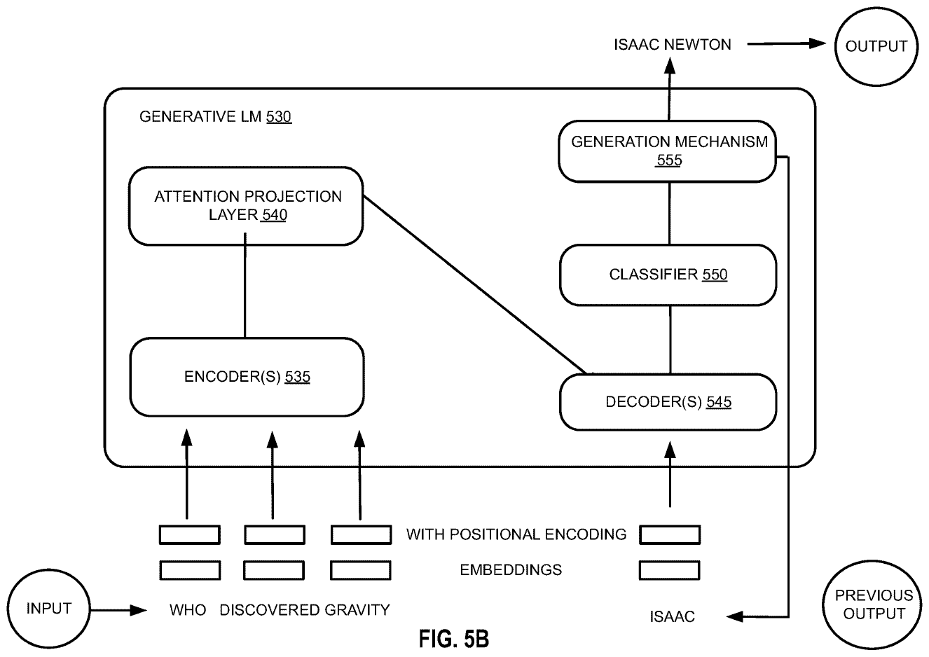

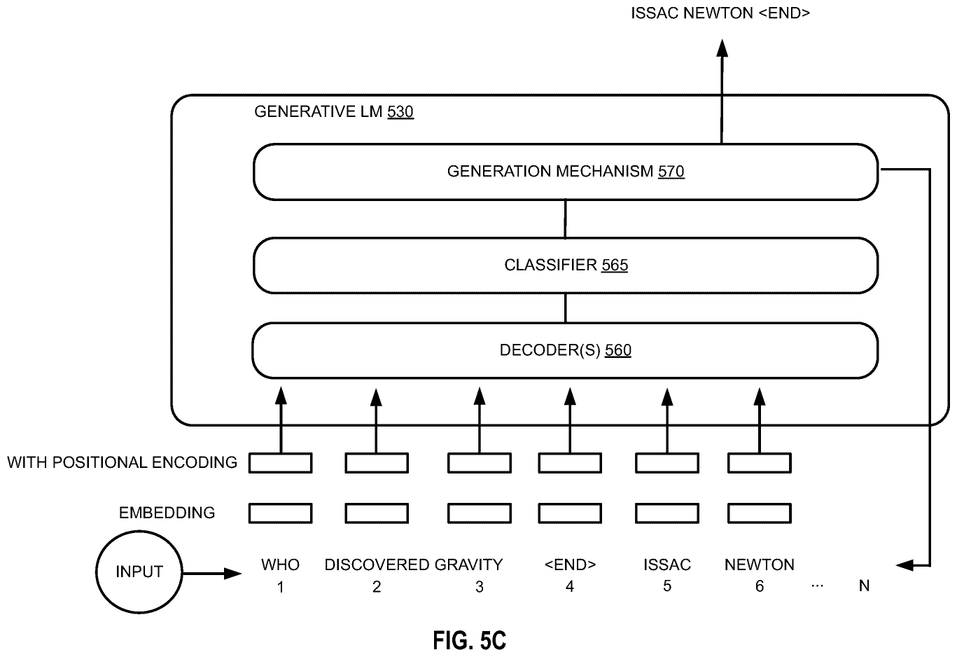

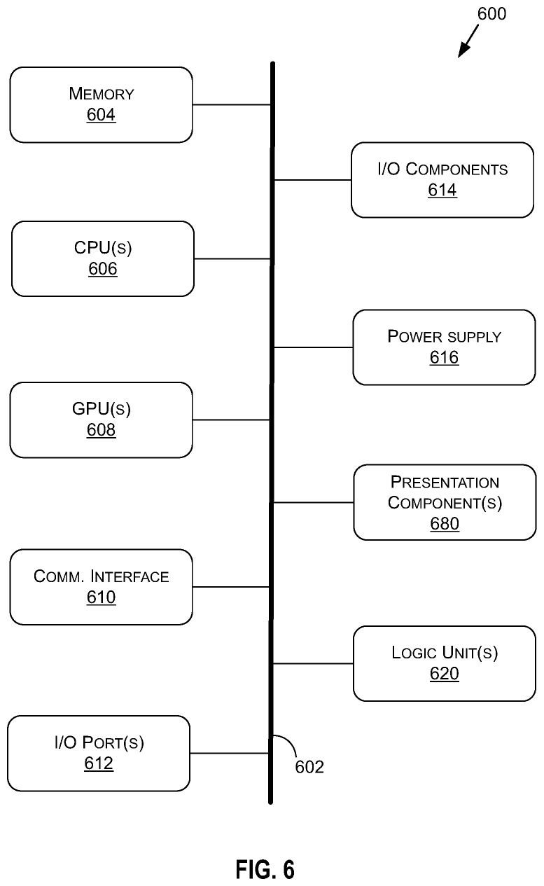

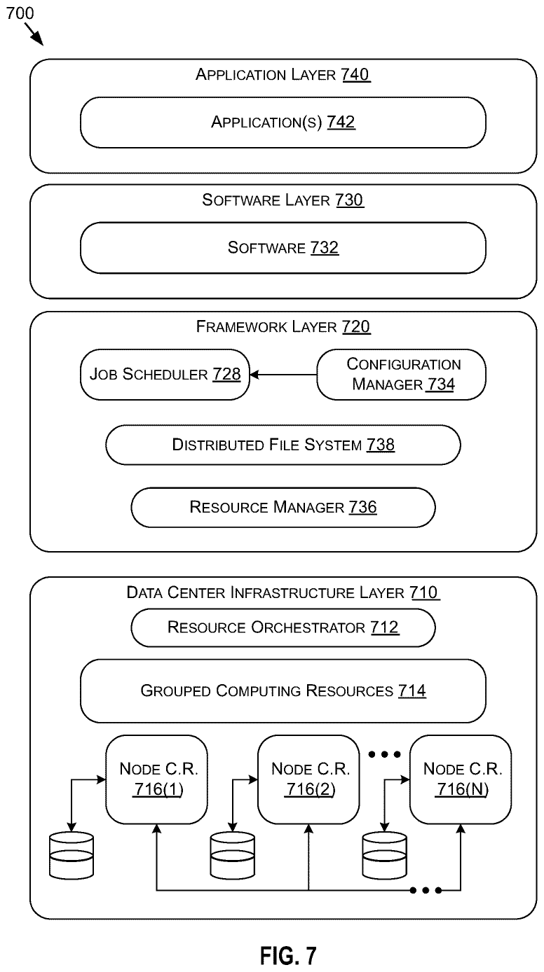

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 500 of FIG. 5A, example generative language model (LM) 530 of FIGS. 5B-5C, example computing device 600 of FIG. 6, and/or example data center 700 of FIG. 7.

The system 100 can implement at least a portion of the body generation pipeline, such as a digital modeling pipeline, a shape generation pipeline, a proportional adjustment pipeline. The system 100 can be used to generate digital models and/or train neural networks by any of various systems described herein, including but not limited to synthetic data generation systems, simulation training systems, interactive media systems, human-robot interaction systems, health and fitness modeling systems, digital twin generation systems, and/or augmented reality systems.

Generally, the body generation pipeline can include operations performed by the system 100. For example, the body generation pipeline can include any one or more of a sampling stage, a measuring stage, a modeling stage, and/or an updating stage. Each stage of the body generation pipeline can include one or more components of the system 100 that collectively perform the functions described herein. In some implementations, one or more of the stages can be performed during the training phase of AI models. Additionally, one or more of the stages can be performed during the inference phase using the AI models.

The system 100 (e.g., implementing the body generation pipeline during an inference phase) can generate an initial model (e.g., base shape determined from the coarse inputs) of a body of a subject according to a plurality of characteristics (e.g., coarse inputs) of the subject body o. In some implementations, implementing the body generation pipeline can include the system 100 determining a plurality of measurements (e.g., measurements of a base shape) of a plurality of structures of the initial model. Additionally, the implementing the body generation pipeline can include the system 100 determining (e.g., by at least one neural network) a plurality of modifications (e.g., deformations, such as circumference and length, predicted by one or more neural networks) to the initial model based at least on the plurality of measurements. That is, the at least one neural network (e.g., proporNet(s), such as, at least one neural network for length deformation and at least one neural network for circumference deformation) can be updated according to training data including a featurized representation (e.g., a principal component analysis (PCA) decomposition of Tripple Gangers into body models with 50 vector representation of body dataset) of example body shapes (e.g., Tripple Gangers dataset) and/or measurements of samples of the featurized representation. In some implementations, implementing the body generation pipeline can include the system 100 updating the initial model (e.g., output of blending the predicted deformations) according to the plurality of modifications. Thus, inferences computed using the body generation pipeline can improve the accuracy and realism of digital body models for applications such as virtual environments, interactive media, and/or synthetic data generation.

In some implementations, the system 100 (e.g., implementing the body generation pipeline during a training phase) can sample an input body shape (e.g., determine and/or otherwise select a body shape from a dataset of existing body shapes (e.g., TGBM, anchor shapes) from one or more datasets of body shapes). In some implementations, implementing the body generation pipeline can include the system 100 measuring a plurality of measurements of a model corresponding to the input body shape. Additionally, implementing the body generation pipeline can include the system 100 applying the plurality of measurements as input to a neural network to cause the neural network to generate an estimated representation of the model. In some implementations, implementing the body generation pipeline can include the system 100 updating the neural network based at least on the input body shape and the estimated representation of the model. Thus, during training in the body generation pipeline can improve the adaptability and efficiency of neural networks for generating diverse and anatomically accurate body models.

In some implementations, the sampling stage can be the stage in the body generation pipeline in which the system 100 can select an input body shape from one or more datasets of existing body shapes, such as TGBM or anchor shapes. The system 100 can include at least one sampler system 102. The sampler system 102 can generate, according to a plurality of characteristics (e.g., coarse inputs, demographic data, statistical distributions, and/or any other body-related characteristics) of a body of a subject, an initial model of the body. That is, the sampler system 102 can generate base shapes determined from coarse inputs. For example, during the sampling stage the sampler system 102 can identify anchor shapes that align with demographic characteristics such as gender, age, and/or stature percentile. In some implementations, the sampler system 102 can generate and/or otherwise perform sampling by retrieving reference body shapes from a dataset and associating them with corresponding demographic characteristics. The plurality of characteristics can be used in selection of anchor shapes and the generation of base shapes. That is, the plurality of characteristics can represent statistical distributions or predefined metrics, such as population percentiles, for body shape generation. For example, the sampler system 102 can use statistical models to interpolate between anchor shapes based on the demographic characteristics of the subject. Additionally, the initial model of the body can be a 3D base shape that can include default anatomical proportions reflective of the characteristics of the subject.

In some implementations, the plurality of characteristics of the body of the subject can include at least one of a gender percentile, an age percentile, a stature percentile, and/or any demographic or anatomical characteristic. That is, the coarse solution inputs can be demographic metrics or statistical data used to define general body shapes. In some implementations, the sampler system 102 can generate the initial model based on using non-linear interpolation of the plurality of characteristics from a set of anchor shapes to a final statured result. The non-linear interpolation can correspond to pre-defined body models representing anatomical proportions across various characteristics such that the sampler system 102 can adaptively generate intermediate body shapes reflective of realistic proportions. The sampler system 102 can use non-linear interpolation by combining anchor shapes through a weighted function that adjusts anatomical features based on input characteristics. Additionally, the set of anchor shapes can be reference body shapes representing configurations such as average shapes for certain age, gender, stature categories, ethnic populations, and/or any other predefined body shape categories. In some implementations, the final statured result can be a generated digital body reflecting one or more characteristics of the subject. For example, the final result can include a body shape that aligns with a specified stature percentile while maintaining proportionality across body structures.

In some implementations, the sampler system 102 can perform sampling by selecting two anchor shapes from a dataset of reference body shapes. For example, the sampler system 102 can select anchor shapes corresponding to a child and a teenager based on the age and gender of the subject. The sampler system 102 can use these anchor shapes to output an unstatured result using non-linear interpolation. For example, the sampler system 102 can apply weighted functions to adjust anatomical features of the anchor shapes, combining them into an intermediate shape. Additionally, the sampler system 102 can determine the stature percentile of the subject by using predefined growth charts (e.g., CDC growth charts) to obtain a final statured result. For example, the sampler system 102 can map the age, gender, and stature percentile of the subject to a proportional output representing realistic body dimensions.

The sampling stage can be used to generate digital bodies for various applications. For example, the sampler system 102 can generate initial models for virtual avatars by selecting anchor shapes that align with demographic characteristics and interpolating them to match a target stature percentile. In another example, the sampler system 102 can create synthetic training data by selecting anchor shapes across diverse demographic groups and blending them using interpolation. In yet another example, the sampler system 102 can generate base shapes for medical applications, such as modeling growth patterns for children based on age and stature percentile. For example, the sampler system 102 can use growth charts (e.g., CDC) to output anatomically accurate digital bodies for specific populations.

In some implementations, the sampler system 102 can perform sampling by applying non-linear interpolation between two anchor shapes, such as A₁ and A₂, to generate an intermediate shape based at least on the age of the subject. For example, the sampler system 102 can use a weighting function ƒ(age) to calculate a proportional combination of the two anchor shapes, outputting an intermediate shape Aₜ=(1−ƒ(age))A₁+ƒ(age)A₂. Additionally, the sampler system 102 can use growth charts that represent size information as a function of age, including but not limited to CDC length-for-age and weight-for-age percentile charts, to map the age of the subject and determine the appropriate anchor shapes for interpolation. For example, the sampler system 102 can align the demographic data of the subject with percentile curves on a chart and calculate ƒ(age).

In some implementations, the sampler system 102 can process coarse input data, such as gender, age, and/or stature percentile, to generate a 3D base shape with default proportions. The sampler system 102 can select anchor shapes from a predefined dataset, such as TGBM, based on demographic characteristics. For example, anchor shapes corresponding to typical proportions for an age and gender combination can be selected. The sampler system 102 can apply the non-linear interpolation between anchor shapes to output an unstatured result that reflects intermediate proportions, using weighted functions tied to the input data. Stature percentile can be incorporated by referencing growth charts, such as CDC percentile curves, to update the proportions of the unstatured result and output a final statured base shape. The final base shape can serve as the foundational 3D model with realistic demographic proportions and is prepared for further refinement.

In some implementations, the sampler system 102 can use and/or otherwise incorporate a pre-defined static component (e.g., a frozen head, a default cranial structure, and/or any other static anatomical feature) as part of the generation process to provide a reference for constructing the 3D base shape. For example, the static component can remain unchanged during interpolation and adjustment. The sampler system 102 can generate predictions for the base shape by determining a set of coefficients, such as

$${β}_{1}^{b} , {β}_{2}^{b} , … , {β}_{n}^{b} ,$$

that can represent components parameterizing the shape of the base body. The static component can be combined with the predictions for the base shape to construct a complete 3D model with default anatomical proportions.

In some implementations, the measuring stage can be the stage in the body generation pipeline in which the system 100 can determine anatomical dimensions of the initial model. The system 100 can include at least one measurement system 104. The measurement system 104 can determine a plurality of measurements (e.g., measurements of the base shape) of a plurality of structures of the initial model. That is, the measurement system 104 can determine dimensions such as lengths, circumferences, and other anatomical attributes of the base shape. For example, during the measuring stage, the measurement system 104 can process the 3D base shape to extract bone lengths, body circumferences, and other structural metrics. In some implementations, the measurement system 104 can determine and/or otherwise perform measuring by using spatial analysis techniques, such as calculating distances between reference points or computing geometric properties of the base shape. The measurements can be used by the measurement system 104 to provide input data for subsequent deformation or refinement processes in the body generation pipeline. The plurality of structures can be regions of the body, such as limbs, torso, or head, segmented for independent analysis. That is, the plurality of structures can include individual anatomical features that can be mapped to corresponding regions of the initial model. For example, the measurement system 104 can segment the model into discrete components, such as arms, legs, or torso, and calculate corresponding measurements for each structure.

In some implementations, the measurement system 104 calculates base measurements, such as, m₁, m₂, . . . mₙ, by analyzing the geometric properties (e.g., lengths, angles, surface areas, and/or any spatial characteristics) of the initial model. That is, analyzing can include determining distances between reference points, evaluating geometric ratios, and/or identifying cross-sectional dimensions. The measurement system 104 can process the 3D base shape to extract spatial dimensions corresponding to anatomical structures, such as lengths and body part circumferences. For example, the measurement system 104 can identify reference points along the 3D shape, calculate the distances between these points to determine lengths (e.g., by computing Euclidean distances, measuring along predefined axes, and/or any other geometric methods), and calculate cross-sectional properties to quantify circumferences (e.g., by fitting geometric contours, calculating perimeter lengths, and/or any other spatial algorithms). The measurement system 104 can use the calculations to generate base measurements as dimensional values for subsequent processing stages. By analyzing the base shape, the measurement system 104 can determine dimensional data from the initial model.

The measurement system 104 can generate the modified measurements for lengths and circumferences by applying predicted changes (e.g., geometric modifications) to the base measurements. The system processes predicted changes for body part lengths and circumferences, denoted as Δ₁, Δ₂, . . . , Δ₃₅, and updates the base measurements accordingly. For example, the measurement system 104 adds predicted length changes (e.g., 35 lengths, such as arm lengths, leg lengths, torso length, and/or any other body part dimensions) to corresponding base length values to generate modified measurements, such as

$${m}_{1}^{l} , {m}_{2}^{l} , … , {m}_{35}^{l} .$$

In some implementations, the measurement system 104 can also update circumferences by applying the predicted changes to base circumference values, generating modified measurements, such as

$${m}_{1}^{c} , {m}_{2}^{c} , … , {m}_{35}^{c} .$$

That is, the measurement system 104 can calculate and apply at least one (e.g., each) adjustment for specific anatomical structures (e.g., 35 structures, such as arms, legs, chest, and/or any other segmented body parts), outputting updated dimensional values used in subsequent deformation and refinement processes.

In some implementations, the measurement system 104 can segment the 3D model into anatomical regions to calculate measurements for at least one (e.g., each) region independently. In some implementations, two or more of the anatomical regions can be calculated together to evaluate combined geometric relationships or overlapping dimensions. The measurement system 104 can identify anatomical regions, such as arms, legs, torso, hands, and/or any other regions, and assign reference points and boundaries specific to at least one (e.g., each) region. For example, the measurement system 104 can isolate the torso and calculates and/or otherwise measures its circumferences. The measurement system 104 can map the predicted changes to corresponding regions of the 3D model and update the measurements for at least one (e.g., each) region to output region-specific modified measurements. The segmented measurements can be used in the body generation pipeline for deformation and blending.

In some implementations, the modeling stage can be the stage in the body generation pipeline in which the system 100 can apply neural networks to process measurements and predict modifications to the initial model. The system 100 can include at least one model system 106. The model system 106 can determine, by at least one neural network (e.g., model(s) 108), based at least on the plurality of measurements, a plurality of modifications (e.g., deformations) to the initial model. That is, the at least one neural network (e.g., at least one neural network for length deformation and at least one neural network for circumference deformation) can be updated according to training data including a featurized representation (e.g., PCA decomposition of Tripple Gangers into a body model with 50 vector representation of a body dataset) of example body shapes (e.g., Tripple Gangers dataset) and measurements of samples of the featurized representation. The model system 106 can generate the featurized representation based at least on reducing a dimensionality of a dataset of body shape data to represent the dataset in a lower-dimensional vector space (e.g., using a reduced representation that encodes body shape variations). That is, the model system 106 can apply Principal Component Analysis (PCA) decomposition to a dataset of body shape data to represent the dataset in a lower dimensional vector space. In some implementations, the model system 106 can perform determining by processing the measurements through neural networks trained with the featurized representation. For example, during the modeling stage, the model system 106 can predict changes in body part dimensions based on learned parameters for body shape variations

In some implementations, the model(s) 108 can include a first neural network and a second neural network (e.g., using separate neural networks for length deformations and circumference deformations). In some implementations, the model system 106 can determine determining the plurality of modifications to the initial model by applying the plurality of modifications to the first neural network (e.g., model 108) to cause the first neural network to generate a plurality of length deformations (i.e., predicted adjustments to lengths) of the plurality of modifications to the initial model. In some implementations, the plurality of length deformations can correspond to a first feature vector including a plurality of length measurements for the plurality of structures of the initial model. That is, the measurements can be distributed across various regions of the body (e.g., structures, such as anatomical segments or regions). For example, the first feature vector can be represented as

$${\hat{β}}_{1}^{l} , {\hat{β}}_{2}^{l} , … , {\hat{β}}_{50}^{l} ,$$

where at least one (e.g., each) coefficient can correspond to a component encoding length variations for anatomical structures.

In some implementations, the model system 106 can determine the plurality of modifications to the initial model by applying the plurality of modifications to the second neural network (e.g., model 108) to cause the second neural network to generate a plurality of circumference deformations (e.g., predicted adjustments to circumferences) of the plurality of modifications to the initial model. In some implementations, the plurality of circumference deformations can correspond to a second feature vector including a plurality of circumference measurements for the plurality of structures of the initial model. For example, the second feature vector can be represented as

$${\hat{β}}_{1}^{c} , {\hat{β}}_{2}^{c} , … , {\hat{β}}_{50}^{c} ,$$

where at least one (e.g., each) coefficient can correspond to a component encoding circumference variations for anatomical structures.

In some implementations, the model system 106 can determine a plurality of base shapes of the initial model (e.g., predict the base shapes). That is, the base shapes can be determined based at least on the initial model and using a third neural network of the at least one neural network (e.g., model(s) 108). Additionally, the plurality of base shapes can correspond to a third feature vector including principal component coefficients representing the plurality of base shapes in the initial model. For example, the third feature vector can be represented as

$${\hat{β}}_{1}^{b} , {\hat{β}}_{2}^{b} , … , {\hat{β}}_{50}^{b} ,$$

where at least one (e.g., each) coefficient can correspond to a component encoding variations in base shapes based on demographic and anatomical characteristics.

The model system 106 can include any one or more artificial intelligence models (e.g., machine learning models, supervised models, neural network models, deep neural network models), rules, heuristics, algorithms, functions, or various combinations thereof to perform operations including generating predictions for body shape deformations, such as length or circumference adjustments. That is, the models 108 can be neural networks and/or machine-learning (ML) models trained to predict dimensional modifications for body structures based on input measurements. In some implementations, the model system 106 can output predicted deformations (e.g., length deformations, circumference deformations, base shape predictions, and/or any coefficients representing body shape variations). For example, the output can be a first feature vector (e.g., estimation for length deformations). In another example, the output can be a second feature vector (e.g., estimation for circumference deformations). In some implementations, the outputs can be provided to the model system 106 to perform blending operations or further refinement processes.

In some implementations, the model system 106 can maintain, execute, train, update, and/or otherwise process, refine, or apply one or more artificial intelligence (AI) models during the modeling stage. In some implementations, the AI model(s) (e.g., the models 108) can include any type of AI model capable of predicting shape variations (e.g., length deformations, circumference deformations) to modify body shapes. For example, a first AI model(s) can be trained and/or updated to estimate length deformations. In another example, a second AI model(s) can be trained and/or updated to estimate circumference deformations. In yet another example, a third AI model(s) can be trained and/or updated to estimate a plurality of base shapes. The AI model(s) can be or include a predictive model (e.g., ProporNet neural network, convolutional neural network, generative adversarial network, and/or any neural network designed to compute proportional deformations or dimensional adjustments). The machine-learning model(s) can be or include a deep neural network, in some implementations. The model system 106 can execute the AI model to generate outputs. The model system 106 can receive data to provide as input to the AI model(s), which can include coarse inputs, modified length and circumference measurements, base measurements, and/or any predicted shape parameters.

Generally, a ProporNet neural network can be a feedforward neural network configured to process dimensional input data and predict shape variations. The ProporNet neural network can include one or more layers. For example, a first layer can be a linear layer [35,256] and a second layer can be a linear layer [256,50]. In some implementations, the network can apply non-linear activation functions, such as ReLU, between layers to apply non-linearity into the ProporNet neural network. That is, the activation functions can be used by the ProporNet neural network to perform mappings between input features and output predictions. For example, the first layer can project a 35-dimensional input vector into a 256-dimensional latent space, and the second layer can map the latent space into a 50-dimensional feature space. Additionally, the ProporNet neural network can apply weight regularization or dropout to prevent overfitting during training.

In some implementations, the model system 106 can train and update AI models (e.g., models 108) through the body generation pipeline that includes data preprocessing, feature engineering, and hyperparameter tuning. The preprocessing stage can include normalizing datasets, processing missing data, and augmenting inputs for training the AI models. Feature engineering can include dimensionality reduction techniques, such as principal component analysis (PCA) or t-SNE. The models 108 can incorporate attention mechanisms, ReLU activations, and layered architectures to facilitate learning. In some implementations, the model system 106 can evaluate trained models using performance metrics (e.g., mean squared error loss, precision, recall, and/or F1 score) and/or any benchmarks, to determine readiness for deployment and/or inference operations.

In some implementations, the models 108 can include two or more layers (e.g. and without limitation, [35, 256] linear layer, [256, 50] linear layer, and/or any hidden layers). That is, the models 108 can process feature vectors through these layers to predict body shape deformations. For example, the first linear layer can map measurements to an intermediate feature representation. In this example, the input to the linear layer can be measurements, such as m₁, m₂, . . . , m₃₅, where the first linear layer can transform these inputs into latent variables. For example, the second linear layer can map latent variables to principal component coefficients. In this example, the output of the second linear layer can be coefficients, such as PCA coefficients β₁, β₂, . . . , βₙ, where the second linear layer can represent dimensional variations in body shapes. In some implementations, the length prediction neural network (e.g., model 108) can output

$${\hat{β}}_{1}^{l} , {\hat{β}}_{2}^{l} , … , {\hat{β}}_{50}^{l}$$

from the second linear layer. For example, the model 108 can generate feature vectors encoding predicted length deformations. In some implementations, the circumference prediction neural network (e.g., model 108) can output

$${\hat{β}}_{1}^{c} , {\hat{β}}_{2}^{c} , … , {\hat{β}}_{50}^{c}$$

from the second linear layer. For example, the model 108 can generate feature vectors encoding predicted circumference deformations. In some implementations, the base shape prediction neural network (e.g., model 108) can output

$${\hat{β}}_{1}^{b} , {\hat{β}}_{2}^{b} , … , {\hat{β}}_{50}^{b}$$

from the second linear layer. For example, the model 108 can determine coefficients representing base shape proportions for subsequent blending and refinement processes.

In some implementations, the model system 106 can configure (e.g., train, update, fine tune, apply transfer learning to) the models 108 by modifying or updating one or more parameters, such as weights and/or biases, of various nodes of the models 108 responsive to evaluating estimated outputs of the models 108 (e.g., generated in response to receiving training examples in a training dataset, such as a training dataset including lengths, circumferences, or PCA coefficients). The model system 106 can be or include various neural network models, including models that can for operating on or generating data including but not limited to predictions for length deformations, predictions for circumference deformations, predictions for base shapes and/or various combinations thereof.

In some implementations, the model system 106 can be configured (e.g., trained, updated, fine-tuned, has transfer learning performed, etc.) based at least on the training data of the at least one training dataset (e.g., lengths, circumferences, coefficients). For example, one or more example measurements and/or feature vectors of the training data can be applied (e.g., by the model system 106, or in a pre-training process performed by the system 100 or another system) as input to the models 108 to cause the models 108 to generate an estimated output. The estimated output can be evaluated and/or compared with ground truth measurements (or coefficients) of the training data that correspond with the one or more example measurements and/or feature vectors, and the models 108 of the model system 106 can be updated based at least on the mean squared error loss and/or optimization criteria. For example, based at least on an output of predicted coefficients, one or more parameters (e.g., weights and/or biases) of the models 108 of the model system 106 can be updated.

In some implementations, the updating stage can be the stage in the body generation pipeline in which the system 100 can generate a final 3D body shape by applying updates to the initial model. The system 100 can include at least one model updater system 110. The model updater system 110 can update the initial model according to the plurality of modifications. For example, the model updater system 110 can apply blending operations to combine feature vectors representing length deformations, circumference deformations, and base shape predictions to produce a 3D model. That is, the initial model can be updated to obtain a final result from blending of the predicted deformations and/or base shapes and/or stitching of a head. In some implementations, updating the initial model includes blending at least a first feature vector (e.g., predictions for length deformations), a second feature vector (e.g., predictions for circumference deformations), and a third feature vector (e.g., predictions for base shapes). For example, the model updater system 110 can process the feature vectors using a blending algorithm, such as TGBM blending, to calculate the final proportions of the 3D model. Additionally, the second feature vector of the predictions for circumference deformations can be blended based at least one isolating at least one feature of the second feature vector based at least on a body part of the body (e.g., isolate deformation by body part).

The model updater system 110 can process the plurality of feature vectors to generate a final 3D model that can reflect predicted deformations and base shapes. The model updater system 110 can perform blending operations on the first feature vector, corresponding to length deformations

$$( e . g . , {\hat{β}}_{1}^{l} , {\hat{β}}_{2}^{l} , … , {\hat{β}}_{n}^{l} ) ,$$

and the second feature vector, corresponding to circumference deformations

$$( e . g . , {\hat{β}}_{1}^{c} , {\hat{β}}_{2}^{c} , … , {\hat{β}}_{n}^{c} ) .$$

For example, the model updater system 110 can apply TGBM blending to the length deformations by weighting

$${\hat{β}}_{1}^{l} = 0.6 , {\hat{β}}_{2}^{l} = 0.8 ,$$

and blending with associated base measurements, resulting in final values of 1.2, 1.5, and so on. In some implementations, the model updater system 110 can isolate deformations for body parts, such as adjusting

$${\hat{β}}_{2}^{c}$$

for the torso circumference.

In some implementations, the model updater system 110 can integrate the third feature vector, representing base shape predictions

$$( e . g . , {\hat{β}}_{1}^{b} , {\hat{β}}_{2}^{b} , … , {\hat{β}}_{n}^{b} )$$

into the blending process to refine the final body proportions. For example, if the base shape coefficients

$${\hat{β}}_{1}^{b} = 0.7 , {\hat{β}}_{8}^{b} = 0.9$$

can represent the chest and hit ratios, the model updater system 110 can modify these values based on weighted contributions from the length and circumference vectors. In this example, the model updater system 110 can output blended values that maintain anatomical consistency, such as a chest ratio of 0.85 and a hip ratio of 1.05. The adjusted coefficients can be applied to the initial model geometry.

Additionally, the model updater system 110 can integrate a head model into the final 3D body by performing head stitching. For example, the model updater system 110 can align a frozen head model with the body using matching coordinates derived from the base measurements, ensuring accurate positioning. The stitched head model can be aligned, from frozen head data

$$( e . g . , {\hat{β}}_{1}^{head} , {\hat{β}}_{2}^{head} ) ,$$

with the body using spatial alignment parameters from the base measurements. For example, the model updater system 110 can position the head by matching the neck circumference and vertex alignment points. The stitched head model can undergo final adjustments to match the blended body proportions, resulting in a complete and realistic 3D model suitable for downstream applications.

The final result can be generated by progressively refining the initial model using the model updater system 110. The initial model can be created based on coarse inputs (e.g., gender, age, stature percentile) and can be analyzed during the measuring stage to extract base measurements of anatomical structures. The measurements can be input to the modeling stage, where neural networks can predict length deformations, circumference deformations, and/or base shape coefficients. The model updater system 110 can process the outputs by blending the deformation vectors and base shape coefficients while isolating body part-specific changes for targeted modifications. The model updater system 110 can perform head model stitching using, for example, neck alignment data (e.g., applying geometric adjustments to align the vertex data of the neck and head regions, such as matching neck circumference predictions to head attachment points). After stitching, the model updater system 110 can integrate all updates into a representation by blending the modified body part measurements and base shapes.

In some implementations, the neural networks can be changed individually and/or in combination. During training, the model system 106 can use the sampler system 102 of the system 100 to sample an input body shape (e.g., a body shape from a dataset having various body shapes, such as, Tripple Gangers Body Model (TGBM), anchor shapes, probabilistic samples, and/or any predefined body shapes) from one or more datasets of body shapes. That is, the sampler system 102 can generate a selection of input shapes using probabilistic sampling or deterministic criteria. In some implementations, the model system 106 can randomly sample the TGBMs by applying a probability distribution to select from the dataset to represent diverse body shapes. In some implementations, the model system 106 can determine betas of the anchor shapes by applying PCA decompositions to body shape data to represent variations. For example, the model system 106 (e.g., using the sampler system 102) can obtain β₁, β₂, . . . , βₙ by computing the components from a reduced dimensional dataset. In this example, the model system 106 can parameterize the body shape for the initial model.

In some implementations, the sampler system 102 can determine a set of principal component coefficients, such as β₁, β₂, . . . , β₅₀ to parameterize the shape of the model. The sampler system 102 can generate the coefficients using random sampling from the TGBM dataset and/or structured determination from anchor shapes, with probabilistic weighting assigned to each method (e.g., 75% probability for anchor shape selection, 25% probability for random sampling, and/or any other probability weighting based on, for example, the application). For example, coefficients generated from anchor shapes can be adjusted to represent realistic body shapes that correspond to demographic characteristics. The sampler system 102 can combine the generated coefficients to generate a parameterized representation of the base shape, which can be used to construct the 3D model. The parameterized 3D model can be passed to subsequent stages for measurement and further refinement.

In some implementations, the sampler system 102 can determine a set of anchor shapes from the one or more datasets of body shapes. That is, the set of anchor shapes can include predetermined body shapes representing a plurality of anatomical proportions based at least on one or more characteristics. For example, the one or more characteristics can correspond with at least one of a gender percentile, an age percentile, and/or a stature percentile. In some implementations, the model system 106 can determine, based at least on the set of anchor shapes, a plurality of initial coefficients (e.g., representing a lower-dimensional representation of body shapes) corresponding to at least one shape parameter (e.g., encoding the variations as numerical parameters). For example, the plurality of initial coefficients can correspond to a plurality of shape variations of the set of anchor shapes for the input body shape. In this example, the model system 106 can apply the coefficients to generate a parameterized base shape. In some implementations, the model system 106 can apply a dimensionality reduction operation (e.g., encoding body features into characteristics to reduce data dimensionality) to the one or more datasets of body shapes to generate the plurality of initial coefficients corresponding to a featurized representation of example body shapes within the one or more datasets of body shapes. For example, the model system 106 can determine and/or otherwise calculate PCA coefficients for each (e.g., at least one) data point in the one or more datasets of body shapes.

In some implementations, during training, the model system 106 can build the 3D shape of the model using β₁, β₂, . . . , βₙ by reconstructing the shape from its featurized representation. For example, the model system 106 can use PCA decoding to transform the coefficients back into a geometric body shape. In some implementations, during training, the model system 106 can use the measurement system 104 to measure a plurality of measurements of a model corresponding to the input body shape. That is, the measurement system 104 can extract dimensions such as lengths and circumferences. That is, the measurement system 104 can calculate anatomical measurements based on reference points and geometry. The model system 106 can obtain m₁, m₂, . . . mₙ such that at least one (e.g., each) measurement can correspond to an anatomical segment. For example, the model system 106 can calculate the lengths of arms, legs, and torso regions. Additionally, the model system 106 can update the plurality of measurements based at least on augmenting the plurality of measurements by applying one or more multipliers or scaling factors (e.g., probabilistic adjustments, geometric scaling, anatomical proportionality adjustments, and/or any factors affecting dimensionality) to the plurality of measurements prior to applying the augmented plurality of measurements as input to the neural network. That is, the model system 106 can augment the measurements by applying random multiplication and/or scaling prior to applying the measurements to models 108.

In some implementations, during training, the model system 106 can apply the plurality of measurements as input to a neural network (e.g., model 108) to cause the neural network to generate an estimated representation of the model, \hat{β}₁, \hat{β}₂, . . . , \hat{β}ₙ. The model 108 can be used to predict deformations based on the provided measurements. That is, unlike during inference, the model 108 can output a single continuous representation representing shape changes. The output (e.g., estimated representation) can be used to update neural network (e.g., the model 108) based at least on the input body shape and the estimated representation of the model. That is, the model system 106 can calculate adjustments based on discrepancies between the predicted and actual coefficient values. In some implementations, updating the model 108 can include determining an error value (e.g., mean squared error loss, cross-entropy loss, hinge loss, and/or any gradient-based metric) based at least on a plurality of output coefficients of the estimated representation of the model and the plurality of initial coefficients corresponding to the input body shape. That is, the model system 106 can perform a comparison between the initial and final beta coefficients. For example, the error value can be propagated back to update weights in the neural network.

Additionally, the model system 106 can update one or more parameters (e.g., weights, biases, activation thresholds, and/or learning rates) of the neural network (e.g., the model 108) based at least on the error value. For example, the model system 106 can use stochastic gradient descent to minimize the error. In this example, the model 108 can be configured to iteratively refine predictions such that the estimated coefficients align with the target values. Thus, a single neural network can be trained to predict both length and circumference deformations but executed in parallel during the inference phase to generate separate feature vectors. The single network can include shared layers for initial feature extraction and specialized branches for length and circumference predictions. For example, during inference, the shared layers can process input measurements and the branches can independently generate the first feature vector for lengths and the second feature vector for circumferences.

In some implementations, similar to the inference phase, the model system 106 can use separate neural networks to perform different types of measurements during training. A first model 108 can be trained and updated for predicting length deformations by processing input data corresponding to anatomical lengths (e.g., limb lengths, torso lengths) and generating a first feature vector that can encode length-specific parameters. A second model 108 can be trained and updated for circumference deformations by processing input data related to body part circumferences (e.g., arm girth, chest circumference) and generating a second feature vector that can encode circumference-specific parameters. Both models can use supervised learning methods, where training datasets include ground truth values for lengths and circumferences and corresponding initial measurements. The models 108 can update their respective parameters (e.g., weights, biases) by minimizing an error value (e.g., mean squared error) between the predicted and ground truth feature vectors. For example, during training, the model system 106 can feed length measurements into the first model 108 and circumference measurements into the second model 108 to generate updated predictions that are used in subsequent stages of the body generation pipeline.

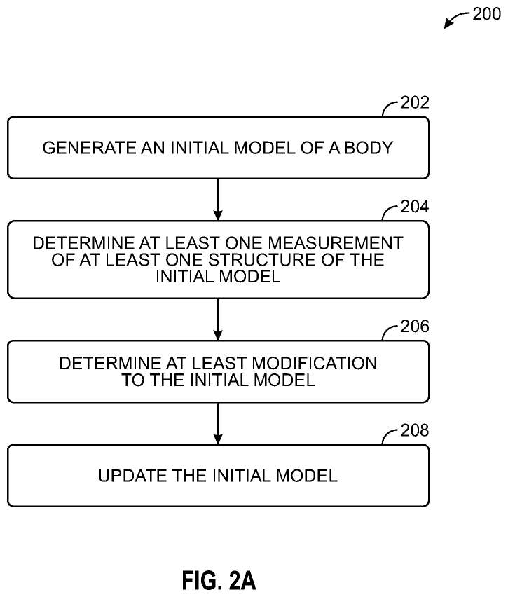

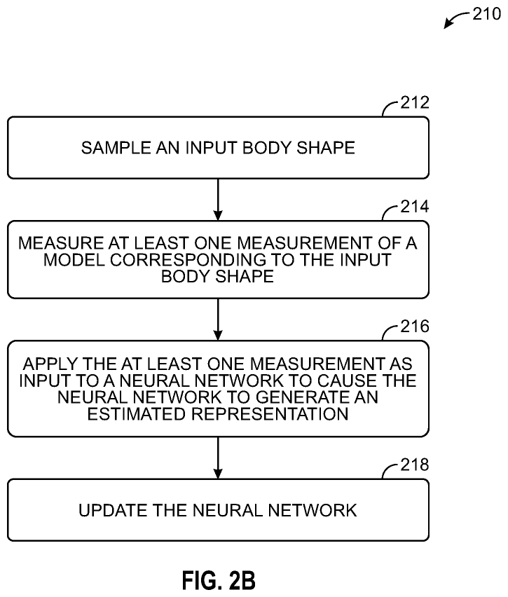

With reference to FIG. 2A, an example flow diagram illustrating a method for body generation in a body generation pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 5A-5C), one or more computing devices or components thereof (e.g., as described in FIG. 6), and/or one or more data centers or components thereof (e.g., as described in FIG. 7).

Now referring to FIG. 2A, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2A is a flow diagram showing a method 200 for generating, determining, determining, and/or updating operations, in accordance with some implementations of the present disclosure. Various operations of method 200 can relate to improving the accuracy and diversity of generated body models. Existing systems often rely on and/or use template-based methods or manual adjustments, which can lead to limited adaptability and unrealistic body shapes. The existing technological problems can arise when these systems fail to account for variations in individual anatomical characteristics, resulting in unrealistic body shape representations. Method 200 of FIG. 2A can solve these technological problems by implementing machine learning-driven modifications and blending processes, thereby improving the generation of realistic and anatomically accurate body shapes.

The method 200, at block 202, includes generating, according to a plurality of characteristics of a body of a subject, an initial model of the body. That is, the characteristics can be coarse inputs and the initial model can be the base shapes determined from the coarse inputs. In some implementations, the plurality of characteristics of the body of the subject can include at least one of a gender percentile, an age percentile, or a stature percentile. Additionally, the processing circuits (e.g., processing circuitry) can generate the initial model using non-linear interpolation of the plurality of characteristics from a set of anchor shapes to a final statured result. That is, the non-linear interpolation can use pre-defined body models representing anatomical proportions across various characteristics. For example, the set of anchor shapes can be reference body shapes (e.g., representing configurations such as average shapes for certain age, gender, stature categories). The final statured result can be a generated digital body that reflects specific characteristics of the subject.

The method 200, at block 204, includes determining a plurality of measurements of a plurality of structures of the initial model. That is, the measurements can be of the base shape. For example, the processing circuits can determine the measurements by analyzing geometric dimensions, such as lengths between reference points and circumferences of cross-sectional regions, of the base shape. In this example, the processing circuits can extract data from the initial model and label measurements for subsequent refinement stages.

The method 200, at block 206, includes determining a plurality of modifications to the initial model. The processing circuits can use at least one neural network to determine the modifications. For example, ProporNet neural networks can be used where a first neural network can be used to predict length deformation and a second neural network can be used to predict circumference deformation. In some implementations, the plurality of modifications can be deformations (e.g., of circumference and length, predicted by respective neural networks). Additionally, the determination of the modifications can be based at least on the plurality of measurements. In some implementations, the at least one neural network can be updated according to training data including a featurized representation (e.g., PCA decomposition of Tripple Gangers into body model with 50 vector representation of body dataset) of example body shapes (e.g., Tripple Gangers dataset) and measurements of samples of the featurized representation.

In some implementations, the at least one neural network of block 206 can include a first neural network and a second neural network. That is, the processing circuits can use separate neural networks for length deformations and circumference deformations. In some implementations, the length deformation neural network and the circumference deformation neural network can be trained and/or implemented separately such that at least one (e.g., each) neural network independently process measurements without interference. For example, the processing circuits can train a ProporNet neural network for length deformations by using segmental datasets annotated with length adjustments and a ProporNet neural network for circumference deformations by using datasets labeled with length changes. In some implementations, the length deformation neural network and the circumference deformation neural network can be trained and/or implemented as the same neural network but configured with branches for predicting at least one (e.g., each) deformation type such that the outputs remain distinct. For example, the processing circuits can train a ProporNet general neural network to utilize shared layers for feature extraction and distinct output layers for length and circumference deformations.

In some implementations, determining the plurality of modifications to the initial model can include applying the plurality of modifications to the first neural network to cause the first neural network to generate a plurality of length deformations of the plurality of modifications to the initial model. That is, the plurality of length deformations can correspond to a first feature vector. For example, the first feature vector can include a plurality of length measurements for the plurality of structures of the initial model. In this example, the measurements can be distributed across various regions of the body (e.g., structures, such as anatomical segments or regions).

In some implementations, determining the plurality of modifications to the initial model can include applying the plurality of modifications to the second neural network to cause the second neural network to generate a plurality of circumference deformations of the plurality of modifications to the initial model. That is, the plurality of circumference deformations correspond to a second feature vector. For example, the second feature vector can include a plurality of circumference measurements for the plurality of structures of the initial model.

In some implementations, the processing circuits can determine, by a third neural network of the at least one neural network, based at least on the initial model, a plurality of base shapes of the initial model. That is, the plurality of base shapes can correspond to a third feature vector. For example, the third feature vector can include principal component coefficients representing the plurality of base shapes in the initial model. In this example, the principal components can be associated with the most significant, relevant, or used characteristics that vary across shapes.

The method 200, at block 208, includes updating the initial model according to the plurality of modifications. That is, the final result can be obtained from blending of the predicted deformations, the predicted base shapes, and/or stitching (e.g., of a head). In some implementations, the initial model can be updated based on blending at least the first feature vector (e.g., predictions from the length deformations), the second feature vector (e.g., predictions from the circumference deformations), and the third feature vector (e.g., predictions for base shapes). Additionally, the second feature vector can be blended by the processing circuits based at least one isolating at least one feature of the second feature vector based at least on a body part of the body (e.g., isolate deformation by body part). In some implementations, the various features can be blended by applying feature-specific interpolation weights and algorithms to combine predicted deformations and base shape characteristics while maintaining anatomical consistency. For example, the processing circuits can blend length and circumference feature vectors by employing weighted averaging methods that consider regional deformation constraints. Additionally, a frozen head and/or a predefined head model can be stitched to the final result by aligning anatomical landmarks such as the neck base and applying transformations to integrate the head with the updated body shape. For example, the processing circuits can map neck dimensions from the body model to the head model and adjust proportions.

With reference to FIG. 2B, an example flow diagram illustrating a method for neural network updating and/or training in a body generation pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 5A-5C), one or more computing devices or components thereof (e.g., as described in FIG. 6), and/or one or more data centers or components thereof (e.g., as described in FIG. 7).

Now referring to FIG. 2B, each block of method 210, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 210 is described, by way of example, with respect to the system of FIG. 1. However, this method can additionally or alternatively be executed by any one system, or any combination of systems, including, but not limited to, those described herein.

FIG. 2B is a flow diagram showing a method 210 for sampling, measuring, applying, and updating operations, in accordance with some implementations of the present disclosure. The method 210, at block 212, includes sampling an input body shape from one or more datasets of body shapes. That is, the processing circuits can select a body shape from a dataset of existing body shapes (e.g., TGBM, anchor shapes). In some implementations, the processing circuits can determine a set of anchor shapes from the one or more datasets of body shapes. The set of anchor shapes capture a range of realistic body structure (e.g., typical body proportions for different demographics). Additionally, the set of anchor shapes can include predetermined body shapes representing a plurality of anatomical proportions based at least on one or more characteristics. For example, the one or more characteristics can correspond with at least one of a gender percentile, an age percentile, and/or a stature percentile.

In some implementations, the processing circuits can determine, based at least on the set of anchor shapes, a plurality of initial coefficients (e.g., representing a lower-dimensional representation of body shapes) corresponding to at least one shape parameter (e.g., encode the variations as numerical parameters). For example, the plurality of initial coefficients can correspond to a plurality of shape variations of the set of anchor shapes for the input body shape. In some implementations, determining the plurality of initial coefficients can include applying a dimensionality reduction operation (e.g., encoding body features into characteristics to reduce data dimensionality) to the one or more datasets of body shapes to generate the plurality of initial coefficients corresponding to a featurized representation of example body shapes within the one or more datasets of body shapes. That is, the dimensionality reduction operation can be Principal Component Analysis (PCA), t-SNE, or any other method for transforming high-dimensional data into a lower-dimensional form. For example, the processing circuits can apply PCA to extract principal components that represent the shape variations across the dataset.

The method 210, at block 214, includes measuring a plurality of measurements of a model corresponding to the input body shape. In some implementations, the processing circuits can measure spatial dimensions of the input body shape by analyzing geometric properties such as lengths and circumferences. That is, the processing circuits can identify reference points on the 3D model, calculate distances between these points to determine lengths, and analyze cross-sectional properties to determine circumferences. For example, the processing circuits can measure limb lengths by calculating the distance between shoulder and wrist reference points and determine chest circumference by analyzing cross-sectional radii at predefined torso locations.

The method 200, at block 216, includes applying the plurality of measurements as input to a neural network to cause the neural network to generate an estimated representation of the model. In some implementations, the processing circuits can process the measurements to generate input vectors that capture dimensional features of the model. That is, the processing circuits can standardize the measurements and pass them as input to a neural network trained for body shape predictions. For example, the processing circuits can input a vector containing lengths and circumferences into the neural network to predict corresponding shape coefficients.

The method 200, at block 218, includes updating the neural network based at least on the input body shape and the estimated representation of the model. For example, a mean squared error loss can be calculated to quantify the difference between the estimated representation and the target representation of the model. In this example, an error value can be determined by calculating the squared differences between predicted and target coefficients, summing them, and normalizing by the number of coefficients such that the network is adjusted to minimize prediction errors. That is, updating the neural network can include determining an error value based at least on a plurality of output coefficients of the estimated representation of the model and the plurality of initial coefficients corresponding to the input body shape. In some implementations, the processing circuits can perform a comparison between the initial and final beta coefficients. Additionally, the processing circuits can update one or more parameters of the neural network based at least on the error value (e.g., mean squared error loss).

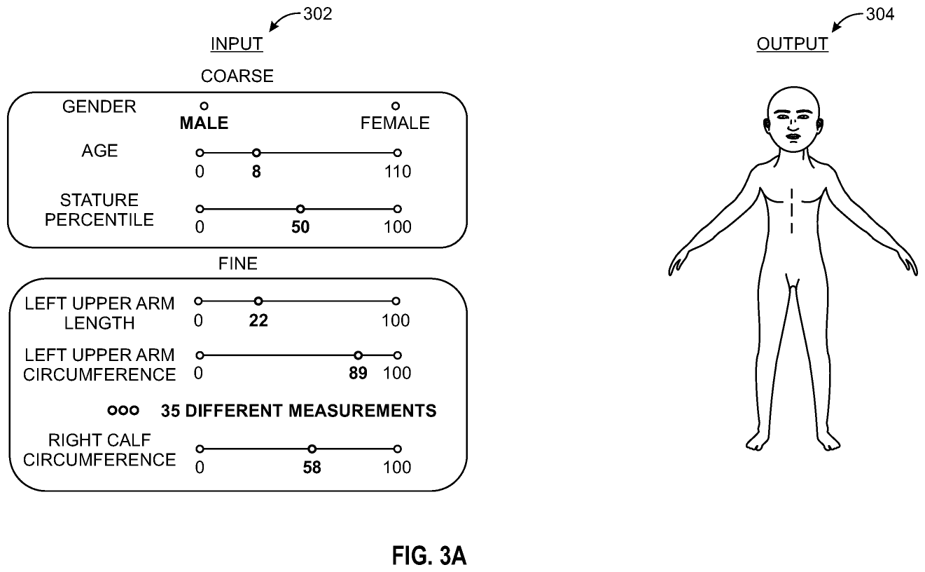

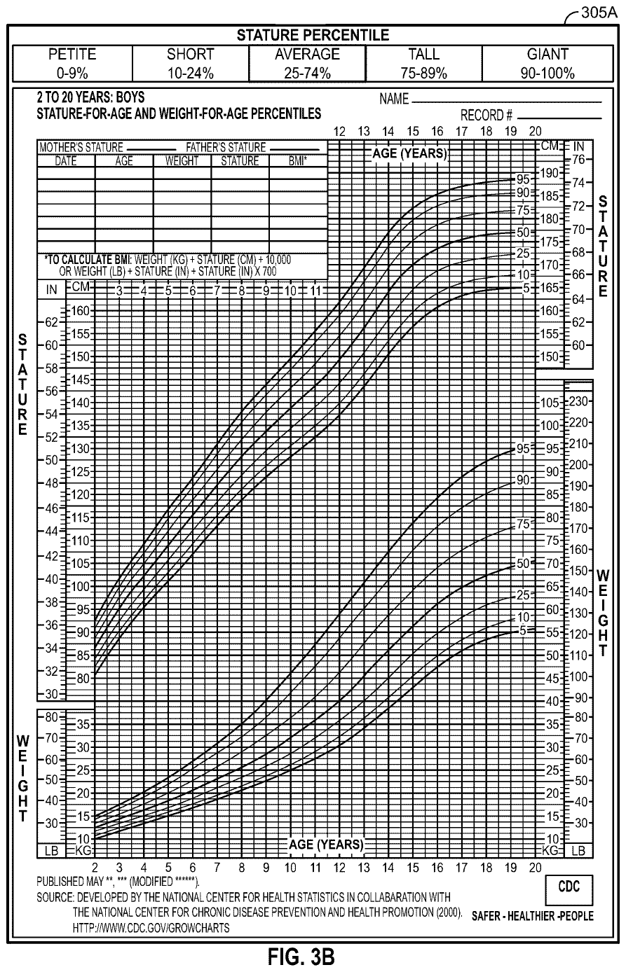

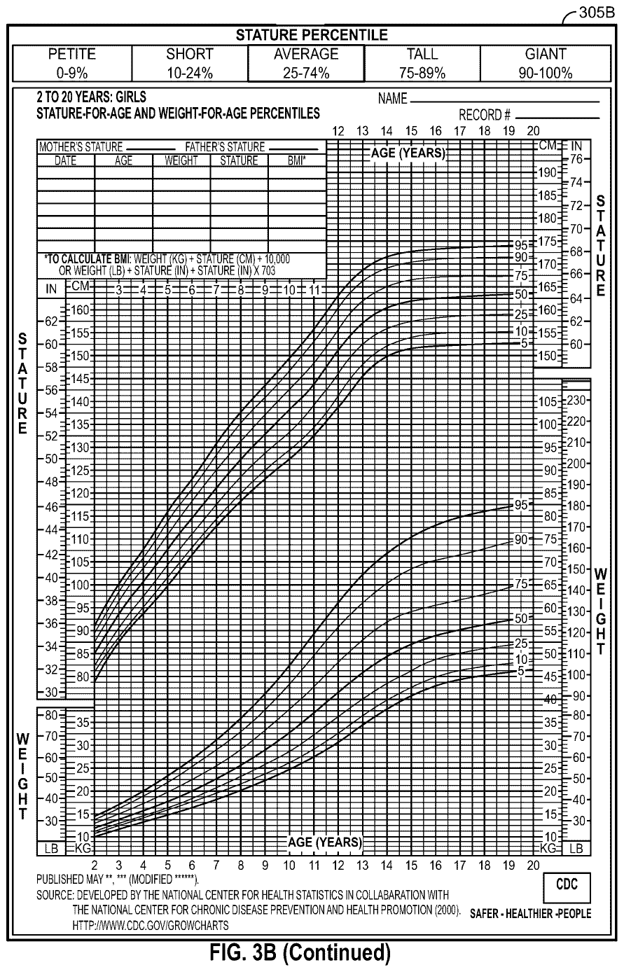

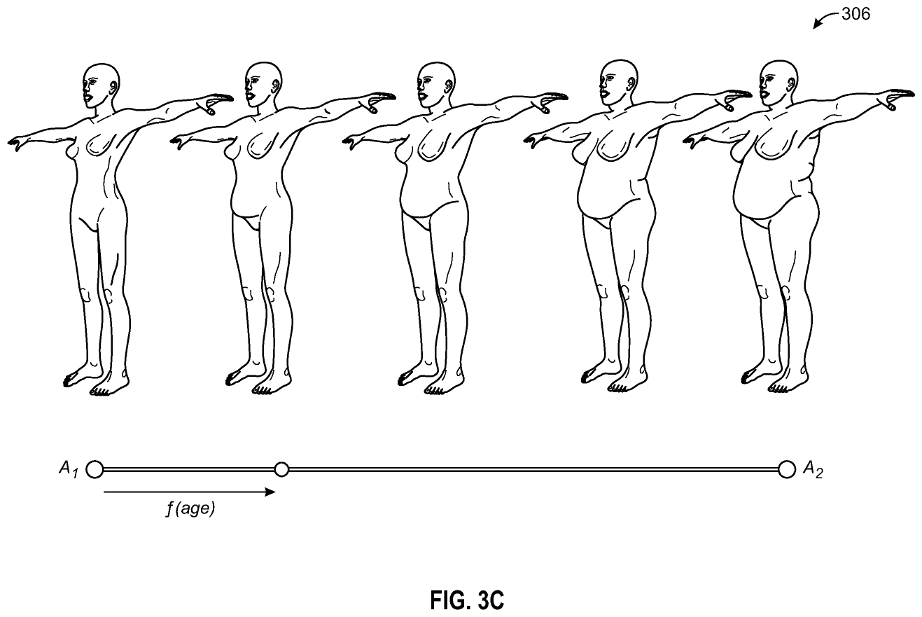

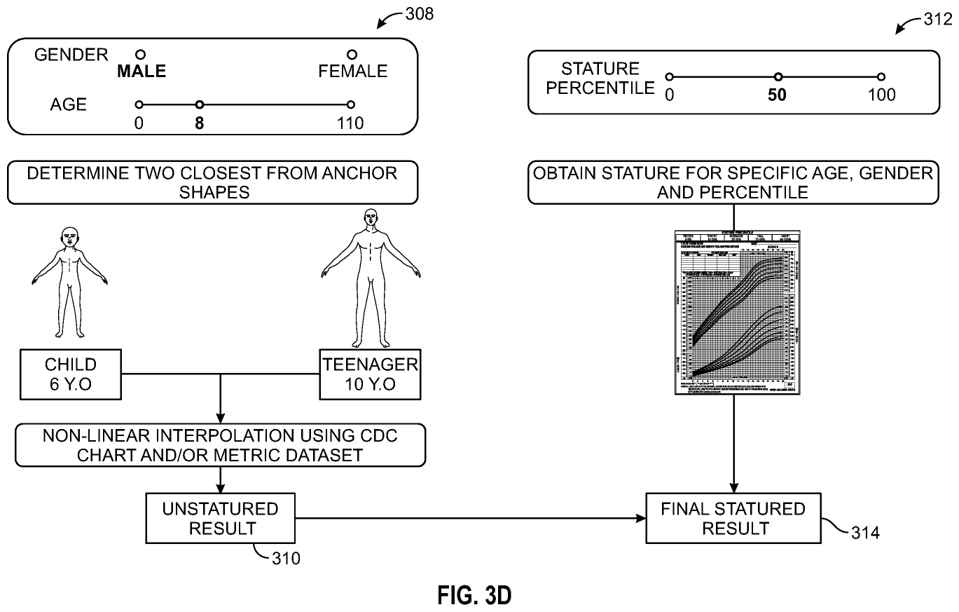

Referring now to FIG. 3A, an example illustration of human figure generation, in accordance with some implementations of the present disclosure. In some implementations, the input data 302 can include including coarse and fine characteristics, for generating a human body. Additionally, coarse inputs can include gender, age, and stature percentile, which can be used to generate base shapes. For example, fine inputs can include left upper arm length (e.g., 22), left upper arm circumference (e.g., 89), and right calf circumference (e.g., 58). The output 304 can reflect a generated human figure based on the provided input parameters.

Referring now to FIG. 3B, an example illustration of coarse selection data 305A and 305B, in accordance with some implementations of the present disclosure. In some implementations, the percentile data can include stature-for-age and weight-for-age percentiles for boys and girls, corresponding to demographic characteristics used as coarse inputs. Additionally, coarse selection data 305A (e.g., graph or chart) can depict percentile curves for boys, and coarse selection data 305B (e.g., graph or chart) can depict percentile curves for girls. For example, the percentile curves can map age and stature inputs to dimensional parameters for interpolation during body shape generation.

Referring now to FIG. 3C, an example illustration of non-linear interpolation 306, in accordance with some implementations of the present disclosure. In some implementations, the interpolation can occur between anchor shapes, such as A₁ and A₂, based on input characteristics such as, age and stature percentile. Additionally, a function of age (e.g., ƒ(age)) can determine intermediate body shapes along the interpolation spectrum. For example, intermediate shapes can represent transitions between anchor shapes.

Referring now to FIG. 3D, a block diagram of a coarse solution process, in accordance with some implementations of the present disclosure. That is, the system 100 can process coarse inputs 308, such as gender, age, and/or stature percentile, to select anchor shapes for interpolation. Additionally, the system 100 can determine anchor shapes for a 6-year-old child and a 10-year-old teenager. For example, non-linear interpolation using collected growth data (e.g., CDC charts and/or metric data) can be used to calculate an unstatured result 310. The system 100 can update the unstatured result to a final statured result 314 based on stature percentile inputs 312.

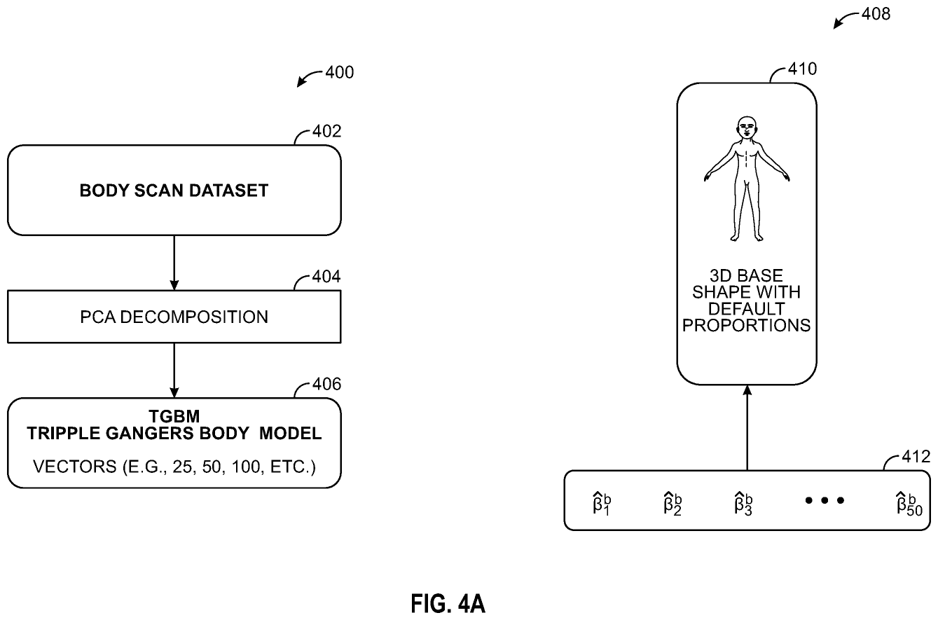

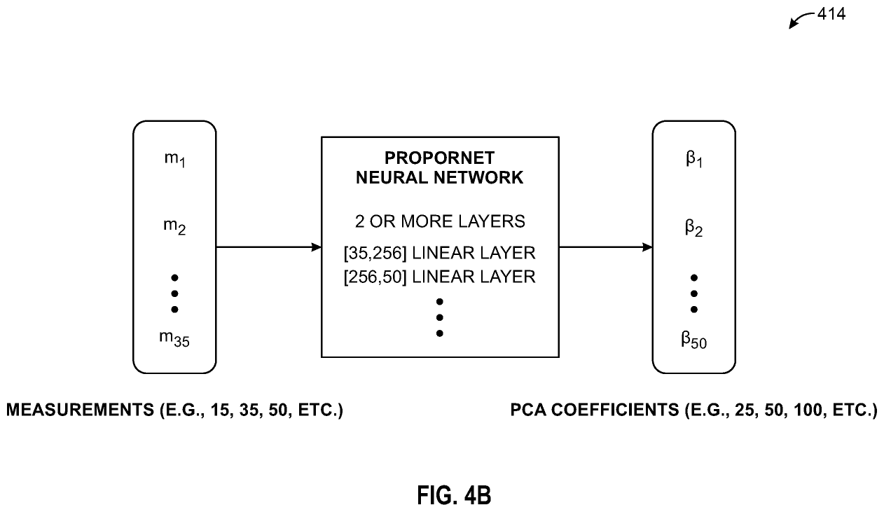

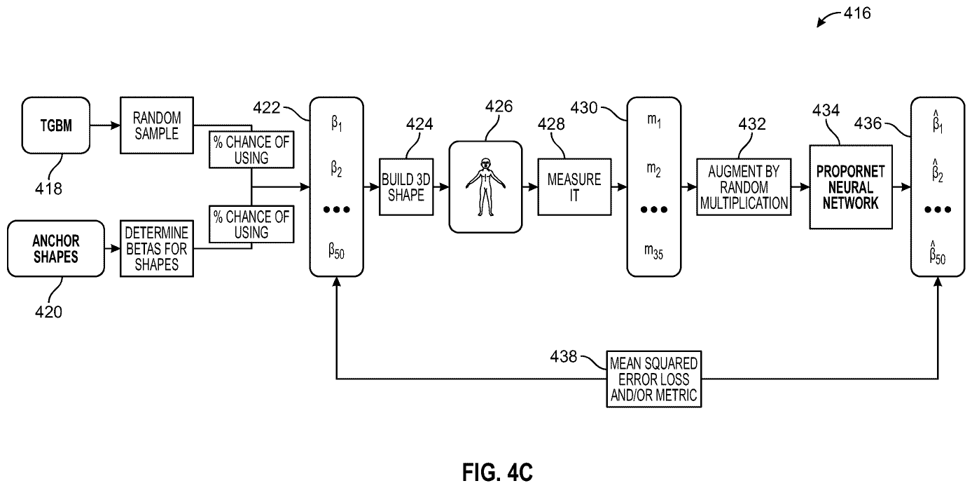

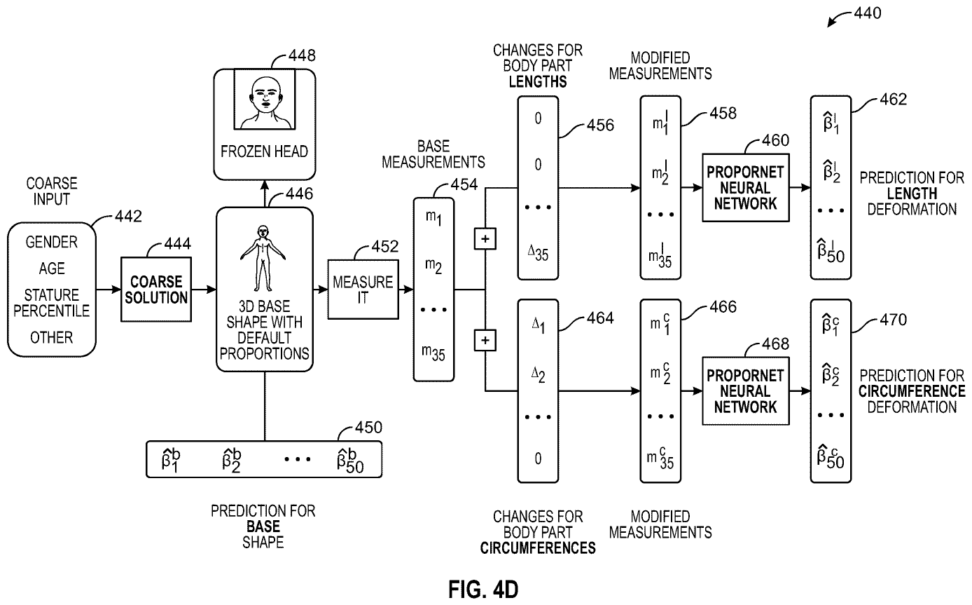

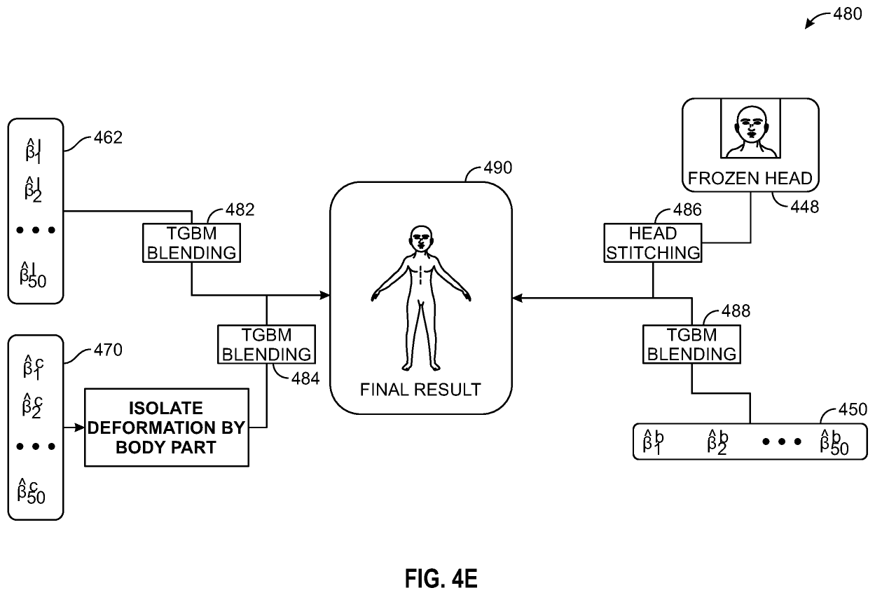

Referring now to FIG. 4A, a block diagram of a fine solution process, in accordance with some implementations of the present disclosure. In some implementations, the vector generation process 400 can include identifying and/or otherwise determining a body scan dataset 402 that represents a dataset of 3D body scans including diverse body shapes. The system 100 can perform PCA decomposition 404 on the body scan dataset 402 to reduce dimensionality and generate a set of principal component coefficients. Additionally, the PCA decomposition 404 outputs vectors 406 for the Tripple Gangers Body Model (TGBM), which can include vectors of varying dimensionalities (e.g., 25, 50, 100). For example, the vectors can represent numerical representations of body shapes in a reduced vector space. The generated TGBM vectors 406 can correspond to coefficients. Additionally, the TGBM vectors 406 can be processed by the system 100 to construct a 3D base shape 410 during base shape construction 408, which can represent the body of the subject with default proportions. For example, the generated 3D base shape 410 can be associated with anatomical features represented by a final feature vector 412.

Referring now to FIG. 4B, a block diagram of a neural network 414, in accordance with some implementations of the present disclosure. In some implementations, the neural network 414 can determine shape coefficients based on measurements and generating PCA coefficients. That is, the neural network 414 can receive input measurements corresponding to dimensions of anatomical features. The input measurements can represent specific anatomical structures (e.g., lengths, circumferences). The neural network 414 can include multiple layers, such as a [35, 256] linear layer and a [256, 50] linear layer. Additionally, the [35, 256] linear layer can process the measurements into intermediate representations and the [256, 50] linear layer outputs PCA coefficients. For example, the output coefficients can represent reduced-dimensional numerical representations of the body shape for subsequent processing.

Referring now to FIG. 4C, a block diagram of neural network updating and/or training 416, in accordance with some implementations of the present disclosure. The neural network updating and/or training 416 can identify and/or otherwise obtain input datasets, such as TGBM 418 and anchor shapes 420. The system 100 can randomly sample body shapes from TGBM 418 based on a probability weighting. The system 100 can determine betas for anchor shapes 420, representing anatomical proportions, and can combine outputs from the random sampling and anchor shape determination to obtain betas 422 based on respective probabilities. The combined coefficients. can be processed at build block 424 to construct a 3D shape 426 that represents the input body shape. The system can measure dimensions of the 3D shape 426 at measurement block 428 and can apply random multiplication at 432 to augment the measurements, in some implementations. The augmented measurements can be input to one or more ProporNet neural networks 434. That is, the ProporNet neural networks 434 can generate predicted coefficients 436. The system 100 can compare the predicted coefficients to the original coefficients using mean squared error loss or another metric at error block 438. The system 100 can update the neural network based on the comparison by adjusting its parameters to minimize the error and improve prediction accuracy.

Referring now to FIG. 4D, a block diagram of a fine solution process 440, in accordance with some implementations of the present disclosure. The system 100 can receive coarse inputs 442, such as gender, age, stature percentile, and other characteristics, to generate a coarse solution 444. The coarse solution 444 can be used to construct a 3D base shape 446 with default proportions. For example, the 3D base shape 446 can be generated using predictions for base shape parameters, represented as coefficients 450. A frozen head 448 can be incorporated into the model to complete the representation of the subject. In some implementations, the 3D base shape 446 can be measured at measurement block 452 to output base measurements 454. Changes for body part lengths can be determine at length block 456, which can be added to and/or incorporated into the base measurements 454 to generate modified length measurements 458. The modified length measurements can be input to a ProporNet neural network 460 to output predictions for length deformation 462. Additionally, changes for body part circumferences 464 can be added to the base measurements 454 to generate modified circumference measurements 466. In some implementations, the modified circumference measurements 466 can be input to a second ProporNet neural network 468 to generate predictions for circumference deformation 470. The system 100 can process predictions for both length and circumference deformations independently while associating them with respective anatomical structures.

Referring now to FIG. 4E, a block diagram of a fine solution final result generation 480, in accordance with some implementations of the present disclosure. In some implementations, predictions for length deformations 462, can be blended using TGBM blending 482. In some implementations, predictions for circumference deformations 470 can be processed to isolate deformation by body part before undergoing TGBM blending 484. In some implementations, the processed outputs can be combined to generate a final result 490. A frozen head 448 can be stitched to the body during head stitching 486, with further TGBM blending 488 applied to integrate predictions for base shape coefficients 450.

### Example Language Models

In at least some implementations, language models, such as large language models (LLMs), vision language models (VLMs), multi-modal language models (MMLMs), and/or other types of generative artificial intelligence (AI) can be implemented. Generally, the language models can process input data to generate structured and parameterized outputs, such as predictions for body deformations, dimensional changes, or base shape representations. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based at least in part on the context provided in input prompts or queries. These language models can be considered “large,” in implementations, based at least in part on the models being trained on massive datasets and having architectures with large number of learnable network parameters (weights and biases)—such as millions or billions of parameters. The LLMs/SLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/SLMs/VLMs/MMLMs/etc. can also include one or more diffusion block(s) (e.g., denoisers). The LLMs/SLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/SLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/SLMs/VLMs/MMLMs/etc.

In various implementations, the LLMs/SLMs/VLMs/MMLMs/etc. can be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/SLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/SLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/SLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based at least in part on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

FIG. 5A is a block diagram of an example generative language model system 500 suitable for use in implementing at least some implementations of the present disclosure. Generally, the example generative language model system 500 can facilitate operations such as sampling, measuring, and updating using neural networks, probabilistic methods, and dimensionality-reduction techniques to output body models with realistic and proportional anatomical structures. In the example illustrated in FIG. 5A, the generative language model system 500 includes a retrieval augmented generation (RAG) component 592, an input processor 505, a tokenizer 510, an embedding component 520, plug-ins/APIs 595, and a generative language model (LM) 530 (which can include an LLM, a SLM, a VLM, a multi-modal LM, etc.).

At a high level, the input processor 505 can receive an input 501 including text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 530 (e.g., LLMs/SLMs/VLMs/MMLMs/etc.). In some implementations, the input 501 includes plain text in the form of one or more sentences, paragraphs, and/or documents. Additionally or alternatively, the input 501 can include numerical sequences, precomputed embeddings (e.g., word or sentence embeddings), and/or structured data (e.g., in tabular formats, JSON, or XML). In some implementations in which the generative LM 530 is capable of processing multi-modal inputs, the input 501 can combine text (or can omit text) with image data, audio data, video data, design data, USD data, and/or other types of input data, such as but not limited to those described herein. Taking raw input text as an example, the input processor 505 can prepare raw input text in various ways. For example, the input processor 505 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 505 can remove stopwords to reduce noise and focus the generative LM 530 on more meaningful content. The input processor 505 can apply text normalization, for example, by converting all characters to lowercase, removing accents, and/or or handling special cases like contractions or abbreviations to ensure consistency. These are just a few examples, and other types of input processing can be applied.

In some implementations, a RAG component 592 (which can include one or more RAG models, and/or can be performed using the generative LM 530 itself) can be used to retrieve additional information to be used as part of the input 501 or prompt. RAG can be used to enhance the input to the LLMs/SLMs/VLMs/MMLMs/etc. with external knowledge, so that answers to specific questions or queries or requests are more relevant—such as in a case where specific knowledge is required. The RAG component 592 can fetch this additional information (e.g., grounding information, such as grounding text/image/video/audio/USD/CAD/etc.) from one or more external sources, which can then be fed to the LLMs/SLMs/VLMs/MMLMs/etc. along with the prompt to improve accuracy of the responses or outputs of the model.

For example, in some implementations, the input 501 can be generated using the query or input to the model (e.g., a question, a request, etc.) in addition to data retrieved using the RAG component 592. In some implementations, the input processor 505 can analyze the input 501 and communicate with the RAG component 592 (or the RAG component 592 can be part of the input processor 505, in implementations) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 592 can retrieve a prior stored conversation history—or at least a summary thereof—and include the prior conversation history along with the current ask/request as part of the input 501 to the generative LM 530.

The RAG component 592 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 592 and the embeddings of the chunks along with the embeddings of the query can be compared to identify the most similar/related embeddings to the query, which can be supplied to the generative LM 530 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLMs/SLMs/VLMs/MMLMs/etc. Rather than (or in addition to) providing the model with chunks of data extracted from larger sized documents—which can result in a lack of context, factual correctness, language accuracy, etc.—graph RAG can also provide structured entity information to the LLMs/SLMs/VLMs/MMLMs/etc. by combining the structured entity textual description with its many properties and relationships, allowing for deeper insights by the model. When implementing graph RAG, the systems and methods described herein use a graph as a content store and extract relevant chunks of documents and ask the LLMs/SLMs/VLMs/MMLMs/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLMs/SLMs/VLMs/MMLMs/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 592 can implement a plugin, API, user interface, and/or other functionality to perform RAG. For example, a graph RAG plug-in can be used by the LLMs/SLMs/VLMs/MMLMs/etc. to run queries against the knowledge graph to extract relevant information for feeding to the model, and a standard or vector RAG plug-in can be used to run queries against a vector database. For example, the graph database can interact with a REST interface plug-in such that the graph database is decoupled from the vector database and/or the embeddings models.

The tokenizer 510 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy can depend on factors such as the language being processed, the task at hand, and/or characteristics of the training dataset. As such, the tokenizer 510 can convert the (e.g., processed) text into a structured format according to tokenization schema being implemented in the particular implementation.

The embedding component 520 can use any known embedding technique to transform discrete tokens into (e.g., dense, continuous vector) representations of semantic meaning. For example, the embedding component 520 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data/video data/etc., the input processor 505 can resize the data to a standard size compatible with format of a corresponding input channel and/or can normalize pixel values to a common range (e.g., 0 to 1) to ensure a consistent representation, and the embedding component 520 can encode the image data using any known technique (e.g., using one or more convolutional neural networks (CNNs) to extract visual features). In some implementations in which the input 501 includes audio data, the input processor 505 can resample an audio file to a consistent sampling rate for uniform processing, and the embedding component 520 can use any known technique to extract and encode audio features—such as in the form of a spectrogram (e.g., a mel-spectrogram). In some implementations in which the input 501 includes video data, the input processor 505 can extract frames or apply resizing to extracted frames, and the embedding component 520 can extract features such as optical flow embeddings or video embeddings and/or can encode temporal information or sequences of frames. In some implementations in which the input 501 includes multi-modal data, the embedding component 520 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 530 and/or other components of the generative LM system 500 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 520 can apply an encoded representation of the input 501 to the generative LM 530, and the generative LM 530 can process the encoded representation of the input 501 to generate an output 590, which can include responsive text and/or other types of data.

As described herein, in some implementations, the generative LM 530 can be configured to access or use—or capable of accessing or using—plug-ins/APIs 595 (which can include one or more plug-ins, application programming interfaces (APIs), databases, data stores, repositories, etc.). For example, for certain tasks or operations that the generative LM 530 is not ideally suited for, the model can have instructions (e.g., as a result of training, and/or based at least in part on instructions in a given prompt, such as those retrieved using the RAG component 592) to access one or more plug-ins/APIs 595 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 595 to the plug-in/API 595, the plug-in/API 595 can process the information and return an answer to the generative LM 530, and the generative LM 530 can use the response to generate the output 590. This process can be repeated—e.g., recursively—for any number of iterations and using any number of plug-ins/APIs 595 until an output 590 that addresses each ask/question/request/process/operation/etc. from the input 501 can be generated. As such, the model(s) can not only rely on its own knowledge from training on a large dataset(s) and/or from data retrieved using the RAG component 592, but also on the expertise or optimized nature of one or more external resources—such as the plug-ins/APIs 595.

FIG. 5B is a block diagram of an example implementation in which the generative LM 530 includes a transformer encoder-decoder. Generally, the generative LM 530 can perform models trained for predicting base shapes, length deformations, and/or circumference deformations, by processing parameterized coefficients, input characteristics, and/or augmented datasets. For example, assume input text such as “Who discovered gravity” is tokenized (e.g., by the tokenizer 510 of FIG. 5A) into tokens such as words, and each token is encoded (e.g., by the embedding component 520 of FIG. 5A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 535 of the generative LM 530.

In an example implementation, the encoder(s) 535 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 540 can convert the context vector into attention vectors (keys and values) for the decoder(s) 545.

In an example implementation, the decoder(s) 545 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 535, in an example transformer architecture, each token (e.g., word) flows through a separate path in the decoder(s) 545. During a first pass, the decoder(s) 545, a classifier 550, and a generation mechanism 555 can generate a first token, and the generation mechanism 555 can apply the generated token as an input during a second pass. The process can repeat in a loop, successively generating and adding tokens (e.g., words) to the output from the preceding pass and applying the token embeddings of the composite sequence with positional encodings as an input to the decoder(s) 545 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 535, except that it creates its queries from the layer below it and takes the keys and values (e.g., matrix) from the output of the encoder(s) 535.

As such, the decoder(s) 545 can output some decoded (e.g., vector) representation of the input being applied during a particular pass. The classifier 550 can include a multi-class classifier including one or more neural network layers that project the decoded (e.g., vector) representation into a corresponding dimensionality (e.g., one dimension for each supported word or token in the output vocabulary) and a softmax operation that converts logits to probabilities. As such, the generation mechanism 555 can select or sample a word or token based at least in part on a corresponding predicted probability (e.g., select the word with the highest predicted probability) and append it to the output from a previous pass, generating each word or token sequentially. The generation mechanism 555 can repeat the process, triggering successive decoder inputs and corresponding predictions until selecting or sampling a symbol or token that represents the end of the response, at which point, the generation mechanism 555 can output the generated response.

FIG. 5C is a block diagram of an example implementation in which the generative LM 530 includes a decoder-only transformer architecture. For example, the decoder(s) 560 of FIG. 5C can operate similarly as the decoder(s) 545 of FIG. 5B except each of the decoder(s) 560 of FIG. 5C omits the encoder-decoder self-attention layer (since there is no encoder in this implementation). As such, the decoder(s) 560 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 560. As with the decoder(s) 545 of FIG. 5B, each token (e.g., word) can flow through a separate path in the decoder(s) 560, and the decoder(s) 560, a classifier 565, and a generation mechanism 570 can use auto-regression to sequentially generate one token at a time until predicting a symbol or token that represents the end of the response. The classifier 565 and the generation mechanism 570 can operate similarly as the classifier 550 and the generation mechanism 555 of FIG. 5B, with the generation mechanism 570 selecting or sampling each successive output token based at least in part on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 6 is a block diagram of an example computing device(s) 600 suitable for use in implementing some implementations of the present disclosure. Generally, the example computing device(s) 600 can perform operations in the body generation pipeline, such as executing neural networks for determining deformations, generating 3D body models, and updating body shapes based on predictions and measurements. Computing device 600 can include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one implementation, the computing device(s) 600 can include one or more virtual machines (VMs), and/or any of the components thereof can include virtual components (e.g., virtual hardware components). For non-limiting examples, one or more of the GPUs 608 can include one or more vGPUs, one or more of the CPUs 606 can include one or more vCPUs, and/or one or more of the logic units 620 can include one or more virtual logic units. As such, a computing device(s) 600 can include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some implementations, a presentation component 618, such as a display device, can be considered an I/O component 614 (e.g., if the display is a touch screen). As another example, the CPUs 606 and/or GPUs 608 can include memory (e.g., the memory 604 can be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 can represent one or more links or busses, such as an address bus, a data bus, a control bus, or a combination thereof. The interconnect system 602 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 606 can be directly connected to the memory 604. Further, the CPU 606 can be directly connected to the GPU 608. Where there is direct, or point-to-point connection between components, the interconnect system 602 can include a PCIe link to carry out the connection. In these examples, a PCI bus need not be included in the computing device 600.

The memory 604 can include any of a variety of computer-readable media. The computer-readable media can be any available media that can be accessed by the computing device 600. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 604 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 606 can be configured to execute at least some of the computer-readable instructions to control one or more components of the computing device 600 to perform one or more of the methods and/or processes described herein. The CPU(s) 606 can each include one or more cores (e.g., one, two, four, eight, twenty-eight, seventy-two, etc.) that are capable of handling a multitude of software threads simultaneously. The CPU(s) 606 can include any type of processor, and can include different types of processors depending on the type of computing device 600 implemented (e.g., processors with fewer cores for mobile devices and processors with more cores for servers). For example, depending on the type of computing device 600, the processor can be an Advanced RISC Machines (ARM) processor implemented using Reduced Instruction Set Computing (RISC) or an x86 processor implemented using Complex Instruction Set Computing (CISC). The computing device 600 can include one or more CPUs 606 in addition to one or more microprocessors or supplementary co-processors, such as math co-processors.

In addition to or alternatively from the CPU(s) 606, the GPU(s) 608 can be configured to execute at least some of the computer-readable instructions to control one or more components of the computing device 600 to perform one or more of the methods and/or processes described herein. One or more of the GPU(s) 608 can be an integrated GPU (e.g., with one or more of the CPU(s) 606 and/or one or more of the GPU(s) 608 can be a discrete GPU. In implementations, one or more of the GPU(s) 608 can be a coprocessor of one or more of the CPU(s) 606. The GPU(s) 608 can be used by the computing device 600 to render graphics (e.g., 3D graphics) or perform general purpose computations. For example, the GPU(s) 608 can be used for General-Purpose computing on GPUs (GPGPU). The GPU(s) 608 can include hundreds or thousands of cores that are capable of handling hundreds or thousands of software threads simultaneously. The GPU(s) 608 can generate pixel data for output images in response to rendering commands (e.g., rendering commands from the CPU(s) 606 received via a host interface). The GPU(s) 608 can include graphics memory, such as display memory, for storing pixel data or any other suitable data, such as GPGPU data. The display memory can be included as part of the memory 604. The GPU(s) 608 can include two or more GPUs operating in parallel (e.g., via a link). The link can directly connect the GPUs (e.g., using NVLINK) or can connect the GPUs through a switch (e.g., using NVSwitch). When combined together, each GPU 608 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 606 and/or the GPU(s) 608, the logic unit(s) 620 can be configured to execute at least some of the computer-readable instructions to control one or more components of the computing device 600 to perform one or more of the methods and/or processes described herein. In implementations, the CPU(s) 606, the GPU(s) 608, and/or the logic unit(s) 620 can discretely or jointly perform any combination of the methods, processes and/or portions thereof. One or more of the logic units 620 can be part of and/or integrated in one or more of the CPU(s) 606 and/or the GPU(s) 608 and/or one or more of the logic units 620 can be discrete components or otherwise external to the CPU(s) 606 and/or the GPU(s) 608. In implementations, one or more of the logic units 620 can be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 can include one or more receivers, transmitters, and/or transceivers that allow the computing device 600 to communicate with other computing devices via an electronic communication network, included wired and/or wireless communications. The communication interface 610 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 620 and/or communication interface 610 can include one or more data processing units (DPUs) to transmit data received over a network and/or through interconnect system 602 directly to (e.g., a memory of) one or more GPU(s) 608.

The I/O ports 612 can allow the computing device 600 to be logically coupled to other devices including the I/O components 614, the presentation component(s) 618, and/or other components, some of which can be built in to (e.g., integrated in) the computing device 600. Illustrative I/O components 614 include a microphone, mouse, keyboard, joystick, game pad, game controller, satellite dish, scanner, printer, wireless device, etc. The I/O components 614 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 can be include depth cameras, such as stereoscopic camera systems, infrared camera systems, RGB camera systems, touchscreen technology, and combinations of these, for gesture detection and recognition. Additionally, the computing device 600 can include accelerometers or gyroscopes (e.g., as part of an inertia measurement unit (IMU)) that allow detection of motion. In some examples, the output of the accelerometers or gyroscopes can be used by the computing device 600 to render immersive augmented reality or virtual reality.

The power supply 616 can include a hard-wired power supply, a battery power supply, or a combination thereof. The power supply 616 can provide power to the computing device 600 to allow the components of the computing device 600 to operate.

The presentation component(s) 618 can include a display (e.g., a monitor, a touch screen, a television screen, a heads-up-display (HUD), other display types, or a combination thereof), speakers, and/or other presentation components. The presentation component(s) 618 can receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that can be used in at least one implementations of the present disclosure. Generally, the example data center 700 can provide resources to train and update neural networks, store datasets for body modeling (e.g., TGBM or anchor shapes), and facilitate processing of the body generation pipeline across multiple computing systems. The data center 700 can include a data center infrastructure layer 710, a framework layer 720, a software layer 730, and/or an application layer 740.

As shown in FIG. 7, the data center infrastructure layer 710 can include a resource orchestrator 712, grouped computing resources 714, and node computing resources (“node C.R.s”) 716(1)-716(N), where “N” represents any whole, positive integer. In at least one implementation, node C.R.s 716(1)-716(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 716(1)-716(N) can correspond to a server having one or more of the above-mentioned computing resources. In addition, in some implementations, the node C.R.s 716(1)-7161(N) can include one or more virtual components, such as vGPUs, vCPUs, and/or the like, and/or one or more of the node C.R.s 716(1)-716(N) can correspond to a virtual machine (VM).

In at least one implementation, grouped computing resources 714 can include separate groupings of node C.R.s 716 housed within one or more racks (not shown), or many racks housed in data centers at various geographical locations (also not shown). Separate groupings of node C.R.s 716 within grouped computing resources 714 can include grouped compute, network, memory or storage resources that can be configured or allocated to support one or more workloads. In at least one implementation, several node C.R.s 716 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 712 can configure or otherwise control one or more node C.R.s 716(1)-716(N) and/or grouped computing resources 714. In at least one implementation, resource orchestrator 712 can include a software design infrastructure (SDI) management entity for the data center 700. The resource orchestrator 712 can include hardware, software, or some combination thereof.

In at least one implementation, as shown in FIG. 7, framework layer 720 can include a job scheduler 728, a configuration manager 734, a resource manager 736, and/or a distributed file system 738. The framework layer 720 can include a framework to support software 732 of software layer 730 and/or one or more application(s) 742 of application layer 740. The software 732 or application(s) 742 can respectively include web-based service software or applications, such as those provided by Amazon Web Services, Google Cloud and Microsoft Azure. The framework layer 720 can be, but is not limited to, a type of free and open-source software web application framework such as Apache Spark™ (hereinafter “Spark”) that can use distributed file system 738 for large-scale data processing (e.g., “big data”). In at least one implementation, job scheduler 728 can include a Spark driver to facilitate scheduling of workloads supported by various layers of data center 700. The configuration manager 734 can be capable of configuring different layers such as software layer 730 and framework layer 720 including Spark and distributed file system 738 for supporting large-scale data processing. The resource manager 736 can be capable of managing clustered or grouped computing resources mapped to or allocated for support of distributed file system 738 and job scheduler 728. In at least one implementation, clustered or grouped computing resources can include grouped computing resource 714 at data center infrastructure layer 710. The resource manager 736 can coordinate with resource orchestrator 712 to manage these mapped or allocated computing resources.

In at least one implementation, software 732 included in software layer 730 can include software used by at least portions of node C.R.s 716(1)-716(N), grouped computing resources 714, and/or distributed file system 738 of framework layer 720. One or more types of software can include, but are not limited to, Internet web page search software, e-mail virus scan software, database software, and streaming video content software.

In at least one implementation, application(s) 742 included in application layer 740 can include one or more types of applications used by at least portions of node C.R.s 716(1)-716(N), grouped computing resources 714, and/or distributed file system 738 of framework layer 720. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 734, resource manager 736, and resource orchestrator 712 can implement any number and type of self-modifying actions based at least in part on any amount and type of data acquired in any technically feasible fashion. Self-modifying actions can relieve a data center operator of data center 700 from making possibly bad configuration decisions and possibly avoiding underutilized and/or poor performing portions of a data center.

The data center 700 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 700. In at least one implementation, trained or deployed machine learning models corresponding to one or more neural networks can be used to infer or predict information using resources described above with respect to the data center 700 by using weight parameters calculated through one or more training techniques, such as but not limited to those described herein.

In at least one implementation, the data center 700 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 600 of FIG. 6 e.g., each device can include similar components, features, and/or functionality of the computing device(s) 600. In addition, where backend devices (e.g., servers, NAS, etc.) are implemented, the backend devices can be included as part of a data center 700, an example of which is described in more detail herein with respect to FIG. 7.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 600 described herein with respect to FIG. 6. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate, according to a plurality of characteristics of a body of a subject, an initial model of the body;
determine a plurality of measurements of a plurality of structures of the initial model;
determine, by at least one neural network, based at least on the plurality of measurements, a plurality of modifications to the initial model, the at least one neural network updated according to training data comprising a featurized representation of example body shapes and measurements of samples of the featurized representation; and
update the initial model according to the plurality of modifications.

2. The one or more processors of claim 1, wherein the at least one neural network comprises a first neural network and a second neural network, and wherein determining the plurality of modifications to the initial model comprises:
applying the plurality of modifications to the first neural network to cause the first neural network to generate a plurality of length deformations of the plurality of modifications to the initial model; and
applying the plurality of modifications to the second neural network to cause the second neural network to generate a plurality of circumference deformations of the plurality of modifications to the initial model.

3. The one or more processors of claim 2, wherein the processing circuitry are to:
determine, by a third neural network of the at least one neural network and based at least on the initial model, a plurality of base shapes of the initial model.

4. The one or more processors of claim 3, wherein the plurality of length deformations correspond to a first feature vector comprising a plurality of length measurements for the plurality of structures of the initial model, wherein the plurality of circumference deformations correspond to a second feature vector comprising a plurality of circumference measurements for the plurality of structures of the initial model, and wherein the plurality of base shapes correspond to a third feature vector comprising principal component coefficients representing the plurality of base shapes in the initial model.

5. The one or more processors of claim 4, wherein updating the initial model comprises blending at least the first feature vector, the second feature vector, and the third feature vector, and wherein the second feature vector is blended based at least on isolating at least one feature of the second feature vector based at least on a body part of the body.

6. The one or more processors of claim 1, wherein the featurized representation is generated based at least on reducing a dimensionality of a dataset of body shape data to represent the dataset in a lower-dimensional vector space.

7. The one or more processors of claim 1, wherein the plurality of characteristics of the body of the subject comprise at least one of a gender percentile, an age percentile, or a relative stature percentile.

8. The one or more processors of claim 1, wherein generating the initial model comprises using non-linear interpolation of the plurality of characteristics from a set of anchor shapes to a final statured result.

9. The one or more processors of claim 1, wherein the one or more processors are comprised in at least one of:
a system for performing collaborative content creation for 3D assets;
a system for performing deep learning operations;
a system for generating or presenting one or more of augmented reality content, virtual reality content, or mixed reality content;
a system for performing simulation operations;
a system for performing real-time streaming;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a control system for an autonomous or semi-autonomous machine;
a perception system for an autonomous or semi-autonomous machine;
a system for performing digital twin operations;
a system for performing light transport simulation;
a system for performing remote operations;
a system implemented using an edge device;
a system implemented using a robot;
a system for performing conversational AI operations;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.

10. One or more processors comprising processing circuitry to:
sample an input body shape from one or more datasets of body shapes;
measure a plurality of measurements of a model corresponding to the input body shape;
apply the plurality of measurements as input to a neural network to cause the neural network to generate an estimated representation of the model; and
update the neural network based at least on the input body shape and the estimated representation of the model.

11. The one or more processors of claim 10, wherein the processing circuitry are to:
determine a set of anchor shapes from the one or more datasets of body shapes, wherein the set of anchor shapes comprising predetermined body shapes representing a plurality of anatomical proportions based at least on one or more characteristics, the one or more characteristics corresponding with at least one of a gender percentile, an age percentile, or a stature percentile.

12. The one or more processors of claim 11, wherein the processing circuitry are to:
determine, based at least on the set of anchor shapes, a plurality of initial coefficients corresponding to at least one shape parameter, wherein the plurality of initial coefficients corresponding to a plurality of shape variations of the set of anchor shapes for the input body shape.

13. The one or more processors of claim 12, wherein determining the plurality of initial coefficients comprises:
applying a dimensionality reduction operation to the one or more datasets of body shapes to generate the plurality of initial coefficients corresponding to a featurized representation of example body shapes within the one or more datasets of body shapes.

14. The one or more processors of claim 12, wherein updating the neural network comprises:
determining an error value based at least on a plurality of output coefficients of the estimated representation of the model and the plurality of initial coefficients corresponding to the input body shape; and
updating one or more parameters of the neural network based at least on the error value.

15. The one or more processors of claim 10, wherein the processing circuitry are to:
update plurality of measurements based at least on augmenting the plurality of measurements by applying one or more multipliers or scaling factors to the plurality of measurements prior to applying the augmented plurality of measurements as input to the neural network.

16. A method, comprising:
generating, using one or more processors according to a plurality of characteristics of a body of a subject, an initial model of the body;
determining, using the one or more processors, a plurality of measurements of a plurality of structures of the initial model;
determining, using the one or more processors by at least one neural network and based at least on the plurality of measurements, a plurality of modifications to the initial model, the at least one neural network updated according to training data comprising a featurized representation of example body shapes and measurements of samples of the featurized representation; and
updating, using the one or more processors, the initial model according to the plurality of modifications.

17. The method of claim 16, wherein the at least one neural network comprise a first neural network and a second neural network, and wherein determining the plurality of modifications to the initial model comprises:
applying, using the one or more processors, the plurality of modifications to the first neural network to cause the first neural network to generate a plurality of length deformations of the plurality of modifications to the initial model; and
applying, using the one or more processors, the plurality of modifications to the second neural network to cause the second neural network to generate a plurality of circumference deformations of the plurality of modifications to the initial model.

18. The method of claim 17, further comprising:
determining, using the one or more processors by a third neural network of the at least one neural network, based at least on the initial model, a plurality of base shapes of the initial model.

19. The method of claim 18, wherein the plurality of length deformations correspond to a first feature vector comprising a plurality of length measurements for the plurality of structures of the initial model, wherein the plurality of circumference deformations correspond to a second feature vector comprising a plurality of circumference measurements for the plurality of structures of the initial model, and wherein the plurality of base shapes correspond to a third feature vector comprising principal component coefficients representing the plurality of base shapes in the initial model.

20. The method of claim 19, wherein updating the initial model comprises blending at least the first feature vector, the second feature vector, and the third feature vector, and wherein the second feature vector is blended based at least one isolating at least one feature of the second feature vector based at least on a body part of the body.
